(19) United States
(12) Patent Application Publication
(10) Pub. No.: US 2006/0167826 A1
(43) Pub. Date: Jul. 27, 2006

(54) Decision-making method used in the absence of clearly-identifiable rules

(75) Inventor: Christophe Labreuche, Antony (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/532,818

(22) PCT Filed: Oct. 27, 2003
(86) PCT No.: PCT/EP03/50757

§ 371 Date: Apr. 26, 2005

(30) Foreign Application Priority Data
Oct. 29, 2002 (FR) 02/13542

(51) Int. Cl. G06N 7/02

(52) U.S. Cl. 706/52

(57) ABSTRACT

The method of the invention is a decision making method used in the absence of clearly identifiable rules, according to which one establishes decision making rules comprising at least two variables for each of which at least one limit is not strict, and it is characterized in that one formally introduces a compensation condition into the nonclearly identifiable rules, that one determines, for each parameter of a compensatory condition, at least one particular point belonging to a compensation boundary and connected with the parameter, that one deduces therefrom the value of the parameters, that one applies the set of rules and that one deduces the decision therefrom.

The present invention pertains to a decision making method used in the absence of clearly identifiable rules.

The rule-based approach is very widely used in numerous expert systems. It allows experts to enter their knowledge in the form of “rules of the trade” as naturally as possible. The rule-based approach allows the expert to provide his expertise directly in explicit and perfectly clear form.

Decision trees are much used to model the making of a decision from among a finite set of alternatives (“alternative” signifying in the present description one of the possibilities offered by a choice). Their main benefit is that they are entirely comprehensible to an expert. A decision tree may be represented as a set of rules. The difficulty is to take account of the inaccuracies and uncertainties of the knowledge of the expert in these decision trees. The inaccuracies and uncertainties are classically modeled by virtue of the use of fuzzy logic. If one considers the following rule “If R₁≧α₁ and R₂≧α₂ then zεC”, then this. This amounts to saying that R₁ is greater than or equal to α₁, and likewise for R₂ with α₂. Inaccuracies and uncertainties are not the only phenomena which are worthy of being modeled. According to the above rule, we have zεC as soon as R₁≧α₁ and R₂≧α₂. Now, obviously, it may happen that numerous practical cases exist in which z ought also to belong to C when R₁ is slightly less than α₁ but R₂ is sufficiently greater than α₂. In this case, one actually expects a good value of the variable R₂ to compensate for a poor value of R₁. Obviously the same holds between a good value of the variable R₁ and a poor value of R₂.

An object of the invention is to be able to model compensation phenomena.

The difficulty is to take account in the decision trees of inaccuracies and uncertainties, as well as compensatory phenomena.

Returning to the rule “If R₁≧α₁ and R₂≧α₂ then zεC”. The consideration of the uncertainties and inaccuracies in the standard rules is conventionally done by virtue of fuzzy logic. This amounts to saying that the condition R₁ may be more or less greater than or equal to α₁ may hold to a greater or lesser extent (with a certain degree) and likewise for R₂ and α₂. One then introduces a fuzzy set V₁ which is nothing other than a function which, with a value of R₁ associates a degree between 0 and 1. This degree equals 0 (that is to say V₁(R₁)=0) if the condition R₁≧α₁ is not satisfied at all, and this degree equals 1 (that is to say V₁(R₁)=1) if the condition R₁≧α₁ is entirely satisfied. In the literature there exist numerous ways of transforming a standard rule into a fuzzy rule. To each way there corresponds an interpretation of the rule. For example, for so-called “certainty” fuzzy rules, this gives: “the more R₁ is greater than α₁ and the more R₂ is greater than α₂, then the more certain it is that zεC”.

The above rule may be written in fuzzy form, in the following generic manner: “If V₁(R₁) AND V₂(R₂) are large, then zεC”. To model the compensatory phenomena, the AND connector in the rule must be extended. In the literature, the extension of the conjunction and disjunction connectors exists. By replacing the AND connector by a generic connector denoted \textcircled{x}, we obtain “If V₁(R₁\textcircled{x} V₂(R₂) is large then zεC”. To model more particularly compensation, one uses a connector of the average type. One then more particularly writes “If F(V₁(R₁), V₂(R₂)) is large then zεC”, where F is a function that will be explained hereinbelow. The compensatory fuzzy rule that has been described with two variables in the premises generalizes to any number of variables. This gives: “If F (V₁(R₁), V₂(R₂), . . . ,Vₙ(Rₙ)) is large, then zΕC”. The number F(V₁(R₁), . . . ,Vₙ(Rₙ)) corresponds to the degree of compensation between 0 and 1. It describes the degree to which compensation occurs and hence the degree to which the rule must be triggered. The concept of degree (and in particular degree of compensation F(V₁(R₁), . . . ,Vₙ(Rₙ)) comes back to the concept of bounded unipolar scale modeling a concept whose converse does not exist and whose degree admits a maximum value, such as is the case for example for satisfaction. The degree is therefore typically modeled in a scale [0,1]. On the other hand, the concept of compensation is based on the concept of bipolar scale (modeling a concept and its converse, such as for example attractivity and repulsion) since, in any compensation phenomenon, there are necessarily positive aspects which compensate for the negative aspects. The utility functions Vᵢ(Rᵢ) must therefore correspond to such scales. One sees therefore that the function F has as argument values belonging to a bipolar scale (the utilities Vᵢ(Rᵢ)) and returns a value belonging to a bounded unipolar scale (the degree of compensation). Consequently, there must therefore exist inside F a function T making it possible to go from a bipolar scale to a bounded unipolar scale. For any values u₁, . . . ,uₙ of its arguments, F may therefore be written F(u₁, . . . ,uₙ)=T (H(u₁, . . . ,uₙ)), where H is an aggregation function such as those used in the multicriteria decision aid realm. The function H models compensation. It is said to be compensatory in the sense that H(u₁, . . . ,uₙ) lies between the smallest value among the uᵢ and the largest value among the uᵢ. An example of a function H is typically the weighted sum: H(u₁, . . . ,uₙ)=Σ_{iε(1, . . . ,n)}α₁ uᵢ.

As we shall detail later, in any compensatory phenomenon, good aspects compensate for poor ones. The good aspects are the variables such that Vᵢ(Rᵢ) is large while poor aspects are the variables such that Vⱼ(Rⱼ) is small. Typically, we have Rᵢ≧α₁ for the good variables, and Rⱼ≦αⱼ for the bad variables. Certain variables Rⱼ may therefore lie above the thresholds αⱼ provided that the other variables are sufficiently below the thresholds. We will then say that the limit αⱼ is not strict.

The concept of fuzzy decision tree exists (cf. J. M. Adamo “Fuzzy decision trees”, Fuzzy Sets & Systems, vol. 4, pp. 207-219, 1980). In the literature, the determination of fuzzy decision trees is done in general by learning techniques. These techniques do not make it possible to introduce fuzziness into an already existing decision tree. Moreover, they do not handle compensatory phenomena.

In a standard fuzzy rule of the type “If U_{α}(x) and U₆₂(y) are large, then zεC”, the fuzzy sets U_{α} and U_{β} are directly palpable to an expert, so that he will be capable of determining them explicitly. This is no longer directly the case in compensatory rules, since the Vᵢ are perceived solely through the function F. It is therefore very difficult, or even impossible, for an expert to provide the values of the Vᵢ and of F directly. This is why no procedure making it possible to do this actually exists.

There exist a certain number of methods that are relatively classical in fuzzy logic which indirectly make it possible to model compensatory phenomena. The first relates to the use of so-called “conjunctive” fuzzy rules (cf. E. H. Mamdani “Application of fuzzy logic to approximate reasoning using linguistic systems” IEEE Transactions on Computers, No. 26, pp. 1882-1191, 1977). This involves “tiling” the set of possible values of each variable Rᵢ by a series of fuzzy sets A_{i,1}, . . . , A_{i,p}. One then creates a rule for each combination of the fuzzy sets: “If R₁εA_{1,k1} and . . . and RₙεA_{n,kn} then zεC” for all k₁, . . . ,kₙ. Each combination of the k₁, . . . ,kₙ provides a different a priori value of C. The fuzzy rule based approach using an aggregation function F consists in describing the compensation globally by virtue of a mathematical function, while this approach consists in describing the compensation point by point (that is to say for any n-tuple k₁, . . . ,kₙ). The major drawback of this approach is “combinatorial explosion” since a rule must be made explicit for all the possible combinations of k₁, . . . , kₙ. Moreover, the conjunctive rules have an interpretation which does not correspond to an implication between the premise conditions and the conclusion, but just to the observation of something which has occurred (cf. D. Dubois & H. Prade, “What are fuzzy rules and how to use them”, Fuzzy Sets & Systems, No. 84, pp. 169-185, 1996). This approach is less relevant than that using the function F.

The second known method is interpolation between rules (cf. D. Dubois & H. Prade, “On fuzzy interpolation”, Int. Journal of General Systems, No. 28, pp. 103-114, 1999). One considers for example two rules which are applied to different values of the variables under the premises: “If R₁εA₁ and . . . and RₙεAₙ then zεC” and “If R₁εB₁ and . . . and RₙεBₙ then zεC′”. The interpolation between these two rules makes it possible to create rules which will be applied to the intermediate values between the Aᵢ and the Bᵢ. The concatenation of all these rules will have a similar effect to the approach using an aggregation function F. On the other hand, the way in which the global compensatory rule is obtained is sidetracked. The consequences of the interpolation may go beyond what the expert initially desired. According to the invention, it is preferable to aid the expert to reason directly as regards compensation.

The decision making method in accordance with the invention is a method according to which one establishes decision making rules comprising at least two variables for each of which at least one limit is not strict, and it is characterized in that one formally introduces a compensation condition into the nonclearly identifiable rules, that one determines, for each parameter of a compensatory condition, at least one particular point belonging to a compensation boundary and connected with the parameter, that one deduces therefrom the value of the parameters, that one applies the set of rules and that one deduces the decision therefrom. It will be noted that the fact that a limit is not strict signifies that the conditions on the corresponding thresholds may be violated.

According to a second characteristic of the invention, the compensation is of binary nature, and there is just one single compensation boundary.

According to a third characteristic of the invention, the conditions in the premises are rendered fuzzy by the expert, the compensation may hold to a greater or lesser extent, there are two compensation boundaries, the application of the rules makes it possible to calculate a degree of possibility regarding the set of possible alternatives, and one must interpret the final distributions of possibility so as to deduce the decision therefrom.

According to a fourth characteristic of the invention, the compensation condition is written as the aggregation by a sum, which is advantageously a simple unweighted sum, of utility functions on each variable, the utility functions are piecewise affine, an expert provides the abscissa of the points delimiting the affine parts, and the parameters of the compensation condition are the ordinates of these points.

According to a fifth characteristic of the invention, the expert provides as relative values with respect to the extreme values the ordinates of the utility functions for all points delimiting the affine parts except for the two extreme points and the threshold, the utility at the threshold is zero and the parameters of the compensation condition are the ordinates of the utility functions for the extreme points.

According to a sixth characteristic of the invention, the utility at the threshold is zero and the parameters of the compensation condition are the ordinates of the utility functions for all points delimiting the affine parts except for the threshold.

According to a seventh characteristic of the invention, the particular points are such that all their coordinates according to the variables except one are equal to one of the values delimiting the affine parts of the utility functions, one requests the expert to provide the value according to the nonfixed coordinate so that the particular point is situated exactly on a compensation boundary, one determines a characteristic point for every variable and every value delimiting the affine parts of the utility function on this variable such that the coordinate of the characteristic point along the variable is equal to the value and such that the ordinate of this value is a parameter (that is to say is unknown), the relations that one has on the characteristic points culminate in a set of system equations whose unknowns are the parameters, and one solves this system with a classical procedure.

According to an eighth characteristic of the invention, the expert determines for each variable the type of compensation to which it belongs, this provides a set of equations and of inequalities to which are appended the equations arising from the characteristic points, and one solves this system according to a classical procedure.

According to a ninth characteristic of the invention, all the variables correspond to a compensation of the type for which, for each variable Rᵢ, there exists a value of Rᵢ above or below which no more compensation is possible regardless of the value according to the other variables, that the expert provides as relative values with respect to the extreme values the ordinates of the utility functions for all points delimiting the affine parts except for the two extreme points and the threshold, that the utility of the threshold is zero, that the parameters of the compensation condition are the ordinates of the utility functions for the extreme points, that fuzziness is introduced, that the conditions in the premises are rendered fuzzy by the expert, that the compensation may hold to a greater or lesser extent, that the characteristic points are such that the component along a well-satisfied variable corresponds to the maximum value along this variable, that the component along a poorly satisfied variable is free, that one asks the expert to provide the value along the free coordinate (not fixed) so that the particular point is situated exactly on a compensation boundary and that all the other components are fixed at the thresholds.

According to a tenth characteristic of the invention, the rule base corresponds to a decision tree.

According to an eleventh characteristic of the invention, the rule base corresponds to a decision tree, and a single alternative is entirely possible in the final distribution of possibilities (this is the hypothesis H described hereinbelow).

According to a twelfth characteristic of the invention, one reveals in the decision tree the pairs of complementary conditions, including the compensation conditions, one processes the complementary conditions at the same time while separating the kernel of their fuzzy set by a very small number.

According to a thirteenth characteristic of the invention, one commences by formally introducing compensation, then one formally introduces fuzziness, then one specifies the noncompensatory fuzzy conditions, and finally one specifies the compensatory fuzzy conditions.

The present invention will be better understood on reading the detailed description of a mode of implementation, taken by way of nonlimiting example and illustrated by the appended drawing, in which:

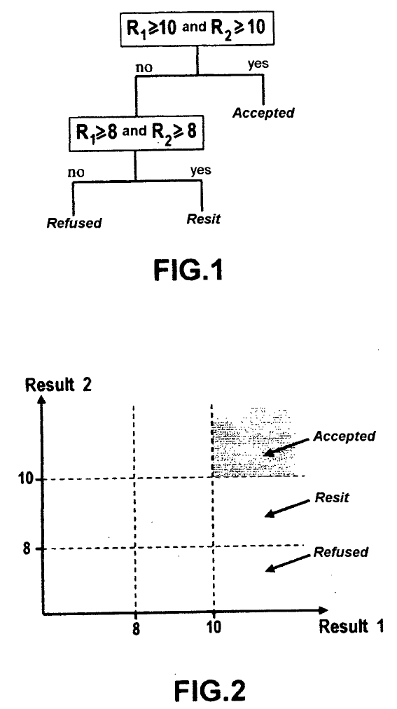

FIG. 1 is an exemplary simplified decision tree serving to explain the invention,

FIG. 2 is a chart plotted in the plane of the two variables of the tree of FIG. 1,

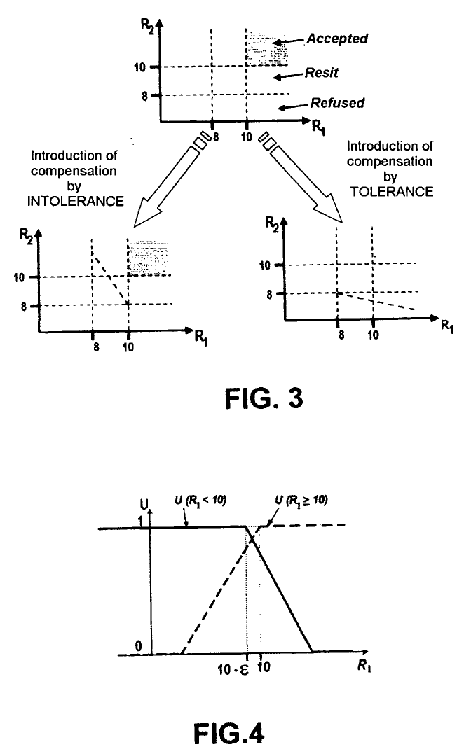

FIG. 3 is a chart like that of FIG. 2, in which the compensations according to the invention have been introduced,

FIGS. 4 to 6 are charts of fuzzy functions used by the invention,

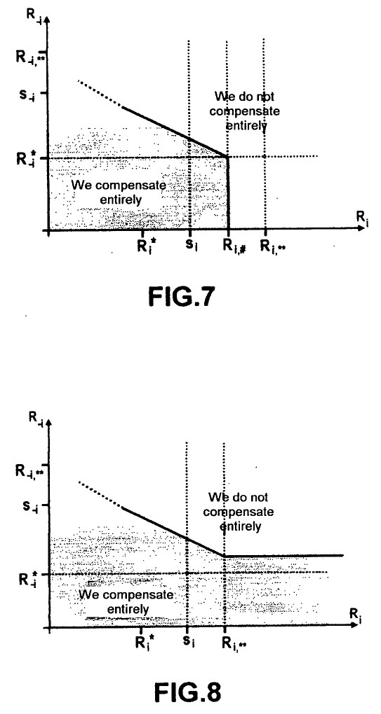

FIGS. 7 to 13 are charts in the plane of the two variables of a decision tree, in which various compensations, in accordance with the invention, have been introduced, and

FIGS. 14 to 16 are charts of utility functions implemented by the invention.

The general characteristics of the method of the invention will first be described succinctly. Thus, we start from the reading of a decision tree in the form of standard rules. The following phases describe the process for taking account of inaccuracies and uncertainties, as well as compensatory phenomena.
P1—introduction of compensation. The explanation of the decision tree in the form of rules shows that we culminate in a partition of the space of variables into various zones, each zone corresponding to the values of the variables leading to a particular alternative. The introduction of a compensation phenomenon induces a modification of the boundary between two zones. We must therefore determine initially to the boundary between which alternatives the compensation chiefly pertains. According to the invention, we determine the zone in which the compensation induces a domain reduction. We then add a conjunction compensation term to the premise conditions of the rule defining this zone. On the other hand, the neighboring zone will get bigger by the part removed from the previous zone. We must then add a disjunction compensation term to the premise conditions of the rule defining this neighboring zone. This compensation term corresponds to the complement of the initial compensation term.
P2—introduction of fuzziness. As stated hereinabove, the premise conditions of the decision tree form a partition of the space of variables. The fact that a partition is obtained implies that whenever a condition is found, its complement is necessarily found somewhere in the same decision tree. Two conditions are complementary if, regardless of the value of the variables, one and only one condition out of these two conditions is entirely true. This corresponds to a hypothesis H described later. In order to introduce fuzziness, the invention proposes that each pair of complementary conditions be handled conjointly so that the hypothesis H is satisfied. Moreover, under the premise condition of the rules, the conjunction and disjunction operators are transformed into minimum and maximum respectively.
P3—specification of fuzziness in the noncompensatory conditions. In order for the hypothesis H to hold, the values for which the fuzzy conditions are entirely satisfied correspond to the values for which the nonfuzzy conditions are satisfied. To determine the values for which the fuzzy conditions are no longer satisfied at all, we can ask the expert questions. As a minimum, it is sufficient to ask a single question per condition.
P4—specification of fuzziness under the compensatory conditions. This forms the subject of a separate process described hereinbelow.

It is not necessary to carry out these steps in the order indicated previously. The order described hereinabove is a preferred example. The relations of precedence between the various phases are: P4 comes after P1 and P2; P3 comes after P2. Moreover, it is perfectly possible to introduce fuzziness but not compensation into a decision tree. In this case, phases P2 and P3 are sufficient. Likewise, it is perfectly possible to introduce compensation into the fuzziness in a decision tree. Phases P1 and P4 are then sufficient. It is in fact possible to use the process P4 to specify the compensation found in a nonfuzzy decision tree.

Characteristics 10 to 13 of the invention pertain to the explanation of compensation in a decision tree. Characteristics 11 to 13 of the invention are more particularly concerned with a decision tree in which one wishes to introduce fuzziness while satisfying the hypothesis H. Characteristic 12 of the invention corresponds to step P2 and consists in particular in handling the pairs of complementary conditions at the same time. Characteristic 13 of the invention consists in using steps P1 to P4 to introduce fuzziness and compensation into a decision tree.

It should be noted that step P4 describes on its own a process which can be considered separately. Specifically, P4 provides a process for explaining a compensatory phenomenon in a fuzzy rule. P4 taken separately can therefore serve to specify the compensation in a condition of the compensation type occurring as a premise of a fuzzy rule.

Characteristics 1 to 9 of the invention pertain to the explanation of compensation in a rule alone, that is to say step P4 taken alone.

The novelty of the method of the invention pertains firstly to the process corresponding to phase P4 (specification of the compensatory fuzzy conditions), and secondly to the fact that introducing fuzziness in a certain manner (by considering the pairs of complementary conditions) so as to ensure that the result (the alternative chosen) satisfies certain properties.

The tricky point in the process consists in formalizing the compensation. In the space of variables, fuzzy compensation is characterized by three zones: one in which we compensate perfectly, another in which we do not compensate at all, and in the middle a zone in which we compensate a little with a degree of compensation lying between 0 and 1. For a point situated in the intermediate zone, the expert will not be capable of determining the degree with which compensation is permitted for this point. We may on the other hand ask the expert which zone a point belongs to. The points for which we deduce the most information belong to the boundary between two zones. Specifically, it is easy to see that each boundary is characterized as a certain level curve of H(V₁(R₁), V₂(R₂), . . . ,Vₙ(Rₙ)), that is to say the set of values of variables R₁, . . . ,Rₙ for which H(V₁(R₁),V₂(R₂), . . . ,Vₙ(Rₙ)) is equal to a certain value, while the fact of belonging to a zone just gives an inequality in H(V₁(R₁), . . . ,Vₙ(Rₙ))—this being less informative. The process therefore consists in asking the expert to specify a certain number of points situated on the boundary between the “we compensate perfectly” zone and the “we compensate a little” zone, and on the boundary between the “we do not compensate at all” zone and the “we compensate a little” zone. The knowledge of these points will make it possible to determine the parameters of the compensation.

In order to determine the utility function Vᵢ defined on the variable Rᵢ, we characterize Vᵢ by a set of discrete points of Rᵢ. This set is denoted [symbol] ᵢ. It is then sufficient to determine the value Vᵢ(xᵢ) of the utility function at each point xᵢ of this set [symbol] ᵢ to fully specify Vᵢ. For example, Vᵢ may be affine between these points.

The method of the invention consists in questioning the expert on a set of singular points of the compensation belonging to the boundary between two zones. These singular points are points all of whose coordinates except one belong to the sets [symbol] ᵢ. We then ask the expert for which value of the last variable is the singular point situated exactly on the boundary between two zones. Such a singular point denoted Rⁱ(Rᵢ) is such that for all k≠i its component in the variable k belongs to the set [symbol] ₖ and its component in the variable i equals Rᵢ. The values of Rⁱ(Rᵢ) along the components other than i are such that when Rᵢ varies, the point Rⁱ(Rᵢ) necessarily cuts one of the two boundaries. If this is the boundary between the “we compensate entirely” zone and “we compensate a little” zone, we obtain this value of Rᵢ by asking up to what value of Rᵢ or onward of what value of Rᵢ—depending on whether the utility function Vᵢ is increasing or decreasing—we compensate entirely for the point Rⁱ(Rᵢ). If this is the boundary between the “we do not compensate at all” zone and the “we compensate a little” zone, we obtain this value of Rᵢ by asking onward on what value of Rᵢ or up to what value of Rᵢ—depending on whether the utility function Vᵢ is increasing or decreasing—we no longer compensate at all for the point Rⁱ(Rᵢ). For each variable j and each point xⱼ of [symbol] ⱼ, we search for a point Rⁱ(Rᵢ), satisfying the previous hypotheses, such that its component along the variable j equals xⱼ. For the value Rᵢ for which Rⁱ(Rᵢ) is located at a boundary, we obtain an equation (corresponding to the fact that H(V₁(Rⁱ(Rᵢ)₁), . . . ,Vₙ(Rⁱ(Rᵢ)ₙ)) is equal to a certain value) in which Vⱼ(xⱼ) is found. By doing this for each variable j and each point xⱼ of [symbol] ⱼ, we thus obtain a system of equations that we can solve in a classical manner.

These equations can also be supplemented with a few inequalities pertaining in particular to the type of compensation desired. We have in fact identified three typical compensation behaviors (denoted R1, R2 and R3 hereinafter). These behaviors make it possible to give a clear definition to the key values of each variable Rᵢ. The relations that are obtained may be solved either directly or via a standard linear program or a linear integer program.

As was indicated above, for each variable j and each point xⱼ of [symbol] ⱼ, we search for a point Rⁱ(Rᵢ), satisfying the previous hypotheses, such that its component along the variable j equals xⱼ. We therefore search for the values of Rⁱ(Rᵢ) in the components other than i and j such that Rⁱ(Rᵢ) cuts at least one of the two level curves when Rᵢ varies. In the favorable cases, we can fix the values of the components of Rⁱ(Rᵢ), i and j excluded, at values whose utilities are already known, while ensuring that Rⁱ(Rᵢ) necessarily cuts one of the two boundaries for a value of Rᵢ. In the other cases we must use values of the components of Rⁱ(Rᵢ), i and j excluded, whose utilities we do not yet know. We cannot then be sure that Rⁱ(Rᵢ) necessarily cuts one of the two level curves since, as a matter of fact, this property depends on the utilities along the components other than i and j which are not yet known. In this case, we can choose the other components which maximize a sort of probability of crossing a level curve.

To finish, we will briefly explain how compensation (without fuzziness) is introduced into a nonfuzzy rule. Here we make reference to the second characteristic of the invention as well as to those which stem therefrom. The fact of culminating at the end of the process in an unequivocal binary decision (“we compensate” or “we do not compensate”) implies that there are only two zones, and hence a single boundary instead of two as previously. Moreover, the function T returns 1 (in this case, “we compensate”) if its argument is greater than a certain value, and 0 (in this case, “we do not compensate”) otherwise. We then proceed as previously, except that we have only a single level curve. Therefore, since we have a single absolute reference level (the value of the level curve), the results will be given to within a homothety (with respect to the value). This will be sufficient to be able to make the comparison with respect to this value with no possible ambiguity.

The present invention will be described hereinbelow with reference to an exemplary decision tree. It is simple, but representative of the phenomena that may arise. The example consists of an end-of-year examination. The examination is composed of two tests. The results according to the two tests are denoted R₁ and R₂. As a function of the results obtained, we have three possible states: Accepted (the end-of-year examination was passed and the student is accepted), Resit (the results are not sufficient to accept the student straightaway, but sufficiently correct to permit him to take an oral resit), and Refused (the examination was failed, and the student is refused). The decision tree represented in FIG. 1 indicates the situation of the student as a function of his results. This decision tree stipulates that R₁ and R₂ must be greater than or equal to 10. If these two conditions are both satisfied, the student is accepted. If not, we look to see whether these two results are both greater than or equal to 8. If they are, the student is passed, if not, he is refused.

In the plane of the variables R₁ and R₂, the zones demarcating the Accepted, Resit and Refused situations are represented in FIG. 2, which faithfully conveys in this plane the decision tree of FIG. 1.

A process making it possible to take account of inaccuracies, uncertainties and compensatory phenomena in decision trees will now be described.

Decision trees are much used to model the making of a decision from among a finite set of alternatives C={C₁, . . . ,Cₕ}. Their main benefit is that they are entirely comprehensible to an expert. The introduction of fuzziness into a tree leads, during the traversal of this decision tree, to the fact that we no longer culminate in a single alternative Cₘ but in a distribution of possibilities δ_{c} over the set of possible alternatives. Thus, for each alternative CₘεC, we determine the degree of possibility δ_{c}(Cₘ) (lying between 0 and 1) that Cₘ is the decision to be made. The interpretation of this distribution of possibilities is then done based on the theory of possibilities.

To introduce fuzziness and compensation into each decision tree, the invention makes provision to start from the standard decision tree. We shall firstly explain how to introduce compensation, and more precisely the form that compensation must take (if there is reason to introduce compensation). We will then describe how to introduce fuzziness.

We begin by introducing compensation into a tree that has not yet been rendered fuzzy. We must start from the writing of a decision tree in the form of standard rules giving the conditions of allocation of each alternative. For the example of the examination, this gives:
“Accepted” if R₁≧10 AND R₂≧10
“Resit” if (8≦R₁<10 AND R₂≧8) OR (R₁≧8 AND 8≦R₂<10)
“Refused” if R₁<8 OR R₂<8

As it is difficult to take account of compensation without a suitable tool, no compensation phenomenon is generally made explicit in trees. It may be that there is no reason to introduce it. On the other hand, the explanations hereinbelow relate to the converse case. The explanation of the decision tree in the form of rules does indeed show that we culminate in a partition of the space of variables into various zones, each zone corresponding to the values of the variables leading to a particular alternative. The introduction of compensation induces a modification of the boundary between two zones. We must therefore determine firstly to which boundary between alternatives the compensation chiefly pertains, and secondly to which variables the compensation applies.

Here we return to the example of the examination. The conditions of acceptance in an examination are in general strict and it can be assumed that it is perhaps not desirable to introduce compensation on the “Accepted” alternative. On the other hand, we may ask ourselves whether a student has to be refused if a result is less than 8 even when the other result is excellent. Likewise, we may ask ourselves whether a student who obtained the score 8 according to the two results is nevertheless worthy of going to a resit session. Stated otherwise, we assume that it is relevant to introduce a compensation at the boundary between the “Resit” and “Refused” alternatives, and that this relates to the variables R₁ and R₂. We will necessarily have to modify the set of values of R₁ and R₂ leading to the “Resit” and “Refused” alternatives. The boundary between these two alternatives may be modified in two ways:
The first way consists in restricting the set of values of R₁ and R₂ leading to the “Resit” alternative. In the absence of compensation, the worst results possibly being able may lead again to a resit R₁=8 and R₂=8. Consequently, in this first way of doing things, a student who obtained the score 8 in the two results does not deserve to go to a resit session. We are more demanding, more intolerant. We now assume that the result R₁ is more significant than the result R₂. In this case, we tolerate a relatively poor value of R₁ only if R₂ has a good enough value. Stated otherwise, we allocate the “Resit” alternative if a rather good value of the result R₂ (that is to say R₂<8) compensates for a relatively poor value of the result R₁ (that is to say for example 8≦R₁<10) . Of course, there are other approaches for restricting the set of values of R₁ and R₂ leading to the “Resit” alternative.
The second way consists in extending the set of values of R₁ and R₂ leading to the “Resit” alternative. Let us assume that the result R₁ is more significant than the result R₂. We then decide to pass a poor value of R₂ (that is to say R₂<8) when R₁ is good enough. We are less demanding, and more tolerant. Stated otherwise, we allocate the “Resit” alternative if a rather good value of the result R₁ (that is to say R₁≧8) compensates for a poor value of the result R₂ (that is to say R₂<8). This is just one approach to extending the set of values of R₁ and R₂ leading to the “Resit” alternative.

FIG. 3 shows these two ways of doing things.

These two ways of introducing compensation are very different. Choosing the type amounts to ascertaining whether all the values of R₁ and R₂ leading to the “Resit” alternative in the initial decision tree actually deserve to have this alternative allocated. To determine the right way of doing things, we can ask the following question:
If R₁=8 and R₂=8, do you actually think that the “Resit” alternative deserves to be allocated?

This amounts to asking whether the worst values of the variables R₁ leading to the alternative in the initial decision tree actually deserve to culminate in this alternative. If the response is positive, then the second way of doing things is the right one.

It is also possible to mix the previous two ways of doing things by restricting on a certain side the values of R₁ and R₂ leading to the “Resit” alternative, and by extending on another side R₁ and R₂ leading to the “Resit” alternative, as represented in the chart of FIG. 3.

We will first examine the case of the introduction of compensation by restriction (intolerance).

Here, compensation restricts the possible values leading to the “Resit” alternative. This implies that compensation is a condition which supplements the already existing conditions. Let us take the example of the examination. The condition of allocating the “Resit” alternative without compensation is:
“Resit” if (8≦R₁<10 AND R₂≧8) OR (R₁≧8 AND 8<R₂<10)

The compensation described previously amounts to restricting the condition 8≦R₁<10 and R₂≧8. In order for the two conditions not to exhibit any mutual intersection, we rewrite this rule:
“Resit” if (8≦R₁<10 AND R₂≧8) OR (R₁≧10 AND 8≦R₂<10)

Since we restrict the values leading to the “Resit” alternative, this implies quite simply that we append a further condition to the condition “8≦R₁<10′ and R₂≧8′ and that this condition pertains precisely to compensation:
“Resit” if (8≦R₁<10 AND R₂≧8 AND R₂ compensates for R₁) OR (R₁≧10 AND 8≦R₂<10)

Without compensation, the condition of allocation of the “Refused” alternative is:
“Refused” if R₁<8 OR R₂<8

With the introduction of compensation by restriction on the “Resit” alternative, we extend the conditions of allocation of the “Refused” alternative. Stated otherwise, in addition to the previous conditions, the “Refused” alternative is also allocated for values which are no longer allocated to the “Resit” alternative when compensation has been introduced. These are the values satisfying the conditions of allocation of the “Resit” alternative without compensation, for which compensation must not occur:
8≦R₁<10 AND R₂≧8 AND R₂ does not compensate for R₁

Hence, in the case of compensation, we have
“Refused” if R₁<8 OR R₂<8 OR (8≦R₁<10 and R₂≧8 and R₂ does not compensate for R₁)

The conditions “R₂ compensates for R₁” and “R₂ does not compensate for R₁” are complementary.

We now examine the cases of the introduction of compensation by extension (tolerance).

Here, compensation extends the possible values leading to the “Resit” alternative. It is easier firstly to explain the alternative for which the domain is restricted. This is the “Refused” alternative. Without compensation, the condition of allocation of the “Refused” alternative is:
“Refused” if R₁<8 OR R₂<8

We restrict the condition “R₂<8”. We therefore append the compensation condition to the condition “R₂<8”, as previously:
“Refused” if R₁<8 OR (R₂<8 AND R₁ does not compensate for R₂)

Here, the compensation condition is “R₁ does not compensate for R₂”. The term “compensation” has a positive connotation. The fact of being able to compensate must therefore culminate in a positive conclusion. Out of the two alternatives “Resit” and “Refused”, it is the allocation of the “Resit” alternative which is the most positive. Thus, one speaks of compensation when arriving at the “Resit” alternative and of noncompensation when culminating in the “Refused” alternative. This is why the compensation condition makes reference to “do not compensate for”.

The conditions of allocation of the other alternative are obtained as previously. We therefore have the “Resit” alternative if the conditions of allocation of the “Resit” alternative without compensation are satisfied or else if we have a lack of noncompensation in the conditions of allocation of the “Refused” alternative:
“Refused” if (8≦R₁<10 AND R₂≧8) OR (R₁≧8 AND 8≦R₂<10) OR (R₂<8 AND R₁ compensates for R₂)

We now examine the case of the introduction of fuzziness into a decision tree.

We must start from the reading of a decision tree in the form of standard rules, with, preferably, already, introduction of compensation.

Reasoning with regard to decision trees affords a beneficial property. Specifically, in a decision tree, we know the alternative allocated for all the possible values according to the variables. Moreover, conditions of allocation of each alternative are explicitly available. It therefore transpires that the domains in which each alternative is allocated form a partition of the space of variables. This implies that whenever we find a condition, we necessarily find its complement somewhere in the same decision tree. For example, R₁≧10 with R₁<10.

Firstly, we examine the case of standard conditions. The introduction of fuzziness will consist in rendering the conditions fuzzy. Instead of considering the condition R₁<10 to be true or false, we define a degree of validity on the condition. For a condition R, we will subsequently denote by U(R) the degree of validity on the condition R. U(R)=1 if the condition R is entirely satisfied, and U(R)=0 if the condition R is not satisfied at all. For example, U(R₁≧10) is the degree of validity of the condition R₁<10 according to the value of R₁.

Therefore, for each condition we must define a degree of validity for the condition and also for its complement. In standard logic, two conditions R and T are complementary if we have either R or T which is true. In the theory of possibilities, this condition becomes:
Hypothesis H: max(U(R), U(T))=1. Moreover, we have either U(R)=1, or U(T)=1.

This condition implies that out of the two conditions R and T, one is always entirely satisfied. Moreover, they cannot be entirely satisfied at the same time. Several ways of satisfying the hypothesis H are possible. We describe one of them for the example of the complementary conditions R₁≧10 and R₁<10:
The condition R₁≧10 is entirely satisfied when R₁≧10. It is not no longer satisfied at all when R₁ is much less than 10. U(R₁≧10) therefore has the shape given in FIG. 4.
The condition R₁<10 is entirely satisfied if R₁<10. Thus, we must have U(R₁<10)<1 for R₁=10. Hence, for R₁=10, only the condition R₁≧10 will be entirely satisfied. In order for these conditions to hold, we set U(R₁<10) equally to 1 if and only if R₁≦10−ε, where ε is a very small value. For the value 10−ε<R₁<10, neither of the two conditions R₁≧10 and R₁<10 holds entirely. These are the only values of R₁ for which the property H does not hold.

In practice, ε will have to be less than the numerical accuracy in the variable R₁. By proceeding in this way, as the value R₁=10 is attainable, we are sure that the values 10−ε<R₁<10 are not numerically attainable. Consequently, the property H holds for all the attainable values of R₁.

Once the various utilities have been defined, we simply obtain the degree of possibility regarding the various conditions appearing in the decision tree. When there are several premise conditions composed with the AND and OR operators, we do the same, replacing AND by a minimum (denoted Λ) and OR by a maximum (denoted ν). Thus, for the example of the examination in the absence of compensation this gives:
δ(Accepted)=U(R₁≧10)ΛU(R₂≧10)
δ(Resit)=(U(R₁≧8)ΛU(R₁<10)ΛU(R₂≧8)) ν(U(R₁≧8)ΛU(R₂≧8)ΛU(R₂<10))
δ(Refused)=U(R₁<8)νU(R₂<8)
   where δ(Accepted), δ(Resit) and δ(Refused) are the degrees of possibility associated with the three possible alternatives.

We have therefore just shown that the introduction of fuzziness into decision trees amounts to rendering each condition fuzzy, the remainder of the work being trivial.

Reasoning conjointly with regard to a condition and its complement ensures that the condition H holds. We now examine the case of compensation conditions. The compensation conditions are of the type “R₂ compensates for R₁” and “R₂ does not compensate for R₁”. We note that these conditions are complementary. We will therefore proceed in exactly the same way as previously. We will firstly examine the case of an expression of a fuzzy condition of the compensation type. We wish to specify the expression for the utility U(R₂ compensates for R₁) of a compensation condition of the type “R₂ compensates for R₁”. We adopt the very general framework in which the variables to be taken into account in the compensation are R₁, . . . , Rₙ. We write N={1, . . . ,n} and R=(R₁, . . . ,Rₙ). The vector R stripped of its R^{ith} component, that is to say (R₁, . . . ,Rᵢ₋₁, Rᵢ₊₁, . . . , Rₙ), is denoted R₋ᵢ. To determine whether the compensation should or should not be allocated, we calculate a utility U(R) which aggregates partial utilities Vᵢ(Rᵢ) according to the different variables. U(R) may then be written in the form of U(R)=H(V₁(R₁), . . . , V₁(R₁)), where H is an aggregation function. Since we wish to model compensation, H is typically a weighted sum H(u)=Σ_{iε{1, . . . ,n}} αᵢ uᵢ. This gives U(R)=Σ_{iε{1, . . . ,n}} αᵢ Vᵢ(Rᵢ). In the case of compensation, certain variables compensate for other variables. This implies that the variables which compensate have satisfactory values while the compensated variables have unsatisfactory values. We therefore see that the utilities Vᵢ must convey satisfactory values and also unsatisfactory values. Moreover, the neutral element (neither good nor bad) exists. It corresponds to a threshold denoted Sᵢ on the variable i. We therefore see that the utilities Vᵢ have the meaning of a bipolar ratio scale in which the positive values correspond to the satisfactory values, the negative values correspond to the unsatisfactory values, and the value 0 corresponds to the neutral element (the threshold). We have Vᵢ(sᵢ)=0. When the values according to all the variables are satisfactory (that is to say above the thresholds), then we of course compensate entirely, since there is no unsatisfactory value apt to prevent or attenuate the compensation. In this case, since all the Vᵢ(Rᵢ) are positive, the global utility U(R) is strictly positive. When all the variables are equal to the thresholds, then we also compensate entirely. We have U(s₁, . . . ,sₙ)=0. On the other hand, if all the variables except one are equal to the thresholds and if this variable is unsatisfactory, then we no longer compensate entirely. In this case, the utility of this variable is negative and the other utilities are zero. Since H is a compensatory function, its value lies between the smallest value among its arguments and the largest. From this we deduce that U(R) is negative in this case. We therefore see that the value U(R)=0 is the smallest value from which we compensate entirely. Stated otherwise, we compensate entirely if and only if U(R)≧0. Likewise, below a certain negative value, we will no longer compensate at all. On the other hand, there is no reason to take a particular value here. We arbitrarily choose the value −1. Hence we do not compensate at all if and only if U(R)≦−1. When −1<U(R)<0, we compensate a little.

In the expression for U(R), we note that Vᵢ is always present in the product α₁Vᵢ. Now, in contradistinction to the fuzzy sets regarding the conditions in the noncompensatory fuzzy rules, Vᵢ does not comprise any absolute reference level, except for the threshold sᵢ enabling Vᵢ to be normalized. Besides, we have arbitrarily chosen the value −1 as limit of “we do not compensate at all” since in actual fact it is not possible to normalize V_{i.} It is therefore not relevant to separate the weight αᵢ of Vᵢ. For this reason, in what follows, the product αᵢVᵢ will be simply denoted Vᵢ. This implies that the weight αᵢ is included within Vᵢ. Consequently, in what follows, U(R) will be equal to Σ_{iε{1, . . . ,n}} Vᵢ(Rᵢ). As previously, we compensate entirely if U(R)≧0, and we no longer compensate at all if U(R)≦−1.

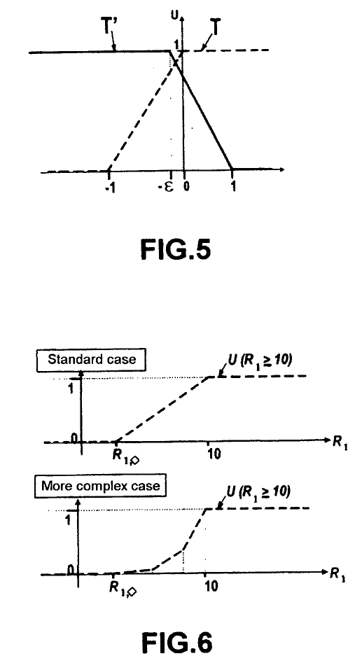

We must transform the value provided by U(R) so as to determine a degree of compensation lying between 0 and 1. We then apply a function T to U(R). Thus, the degree of compensation will equal T(U(R)). In accordance with the foregoing, we compensate entirely if U(R)≧0. Hence, as the degree of compensation equals 1 when we compensate entirely, T(u)=1 if u≧0. Moreover, we do not compensate at all if U(R)≦−1. Hence, as the degree of compensation equals 0 when we do not compensate at all, T(u)=0 if u≦−1. The function T is given in FIG. 5. Hence the utility of the compensation condition is U(compensation in R₁, . . . ,Rₙ)=T(U(R)).

The condition complementary to “compensation in R₁, . . . ,Rₙ” is “noncompensation in R₁, . . . ,Rₙ”. The utility of the complementary condition is simply U (noncompensation in R₁, . . . ,Rₙ)=T′ (U(R)), where the two functions T and T′ must be mutually complementary in the sense of the condition H. There is therefore an ε which separates the kernel of T and T′ (that is to say the values of u such that T(u)=1 and the values of u such that T′(u)=1), as shown in FIG. 5.

We will now examine the case of the introduction of compensation by restriction (intolerance). We return to the example of the examination. The conditions of allocation of the “Resit” and “Refused” alternatives are:
“Resit” if (8≦R₁<10 AND R₂≧8 AND R₂ compensates for R₁) OR (R₁≧10 AND 8≦R₂<10)
“Refused” if R₁<8 OR R₂<8 OR (8≦R₁<10 and R₂≧8 and R₂ does not compensate for R₁)

The conditions “R₂ compensates for R¹” and “R₂ does not compensate for R₁” are complementary. To introduce fuzziness into these conditions, we proceed as described previously, that is to say by replacing AND by Λ and OR by ν:
δ(Resit)=(U(R₁≧8)ΛU(R₁<10)ΛU(R₂≧8) A U(R₂ compensates for R₁)) ν(U(R₁≧10)ΛU(R₂≧8)U(R₂<10)

In the term “U(R₁≧8)ΛU(R₁<10)ΛU(R₂≧8)ΛU(R₂ compensates for R₁)”, the first three conditions make it possible to fix the limits of the compensation, the latter being specified beyond these conditions. The first three conditions ensure the fact that the degree of possibility δ(Resit) is gradual. The last condition is concentrated on the compensation and is not concerned with the smooth transitions outside of these three conditions. We proceed in the same manner for the “Refused” alternative:
δ(Refused)=U(R₁<8)νU(R₂<8)ν(U(R₁≧8)ΛU(R₁<10)ΛU(R₂≧8)ΛU(R₂ does not compensate for R₁))

In accordance with what we showed previously, we have:
U(R₂ compensates for R₁)=T(V₁(R₁)+V₂(R₂))
   and
U(R₂ does not compensate for R₁)=T′(V₁(R₁)+V₂(R₂))

In the case of the introduction of compensation by extension (tolerance), we proceed in exactly the same manner. We will see what this gives in the example of the examination. The conditions of allocation of the “Resit” and “Refused” alternative are:
“Resit” if (8≦R₁<10 AND R₂≧8) OR (R₁≧8 AND 8≦R₂<10) OR (R₂<8 AND R₁ compensates for R₂)
“Refused” if R₁<8 OR (R₂<8 AND R₁ does not compensate for R₂)

The introduction of fuzziness then gives:
δ(Resit)=(U(R₁≧8)ΛU(R₁<10)ΛU(R₂≧8)ΛU(R₂ compensates for R₁))ν(U(R₁≧8)ΛU(R₂≧8)U(R₂<10))ν(U(R₂<8)ΛU(R₁ compensates for R₂))
δ(Refused)=U(R₁<8)ν(U(R₂<8)ΛU(R₁ does not compensate for R₂))
   where:
U(R₁ compensates for R₂)=T(V₁(R₁)+V₂(R₂))
   and:
U(R₁ does not compensate for R₂)=T′(V₁(R₁)+V₂(R₂))

We will now explain the manner in which the fuzzy sets must be specified in a noncompensatory condition.

For a condition R, in order to satisfy the hypothesis H, we have U(R)=1 when the condition R holds in the standard sense (nonfuzzy). We have U(R)=0 when the condition R is no longer satisfied at all. We ask the expert to give the limit point(s) for which R is not satisfied at all. This (these) limit point(s) may also be asked for through the consequences of the fact that U(R)=0 in the decision tree.

We will take the case of U(R₁≧10). Quite often, U(R₁≧10) will be defined by three straight line spans: U(R₁≧10)=1 if R₁≧10, U(R₁≧10)=0 if R₁<R_{1,♦}, and U(R₁≧10) is affine in the middle. In this case, it therefore suffices to provide a unique value R_{1,♦}. This is the value of R₁ below which U(R₁≧10) is zero the whole time. To obtain the value of R_{1,♦}, we may ask the expert:
Below what value of R₁ⁿ, do you think that the condition R₁≧10 is not satisfied at all?

To make this yet more concrete for the expert, we can refer to a consequence regarding the conclusion of the fact that U(R₁≧10)=0. As δ(Accepted)=U(R₁≧10)ΛU(R₂≧10), the fact that U(R₁≧10)=0 implies that the “Accepted” alternative is impossible. We then may ask the expert the following question:
Below what value of R₁ do you think that the “Accepted” alternative should no longer be allocated at all?

When the link between the condition that we are seeking to specify and the alternative is more complex, then the value of the other conditions must be imposed so that the fact that the condition does not hold at all implies that the alternative is no longer possible at all. We then pose a question to the expert making reference to the hypotheses regarding the other conditions.

We therefore see that the expert may reply to only a single question per condition in order to introduce fuzziness (first curve of FIG. 6). On the other hand, there is nothing to compel us to take U(R₁≧10) to be simply affine between R₁=R_{1,♦} and R₁=10. This is necessary when the behavior between R_{1, ♦} and 10 is nonlinear. U(R₁≧10) being interpreted as the possibility regarding the “Accepted” alternative when U(R₂≧10)=1, it may for example happen that the “Accepted” alternative is still almost impossible when R₁ is a little greater than R_{1,♦}, while the “Accepted” alternative is no longer entirely possible at all when R₁ is slightly less than 10, as is the case with the second curve of FIG. 6.

In such cases, the invention makes provision to construct U(R₁≧10) as a piecewise affine function defined by a few points between R_{1,♦} and 10. The value of U(R₁≧10) for these points is determined using a procedure arising out of measure theory and making it possible to construct a difference scale. Such a scale is given to within a translation and a homothety. These two degrees of freedom are fixed by the two conditions U(R₁≧10)=0 when R₁=R_{1,♦} and U(R₁≧10)=1 when R₁=10.

Regarding the condition U(R₁<10), the value onwards of which the condition R₁<10 no longer holds at all is denoted R₁^{♦}.

We will now examine the typical compensation behaviors. Let N={1, . . . ,n} be the set of variables to be taken into account in the compensation. The weighted sum characterizing the compensation may be written U(R)=Σ_{iε{1, . . . ,n}} Vᵢ(Rᵢ), with the notation R=(R₁, . . . ,Rₙ). The vector R stripped of its ith component, that is to say (R₁, . . . , Rᵢ₋₁, Rᵢ₊₁, . . . , Rₙ) is denoted R₋. We compensate entirely if U(R)≧0, and we do not compensate at all if U(R)≦−1. We will specify the utility functions Vᵢ a little more. For practical reasons, we assume that the utility functions Vᵢ are bounded. Thus, Vᵢ admits a maximum value Vᵢ* attained at a point Rᵢ,*: Vᵢ(Rᵢ*)=Vᵢ . Likewise, Vᵢ admits a minimum value Vᵢ,** attained at a point Vᵢ,**: Vᵢ(Rᵢ,**)=Vᵢ,**. The behavior of Vᵢ between Rᵢ,** and Rᵢ* is not specified for the moment, except for the fact that Vᵢ(sᵢ)=0.

The vector (s₁, . . . ,sₙ) belongs to the 0 level curve with U since U(s₁, . . . ,sₙ)=0. We seek to determine the limits on each variable of the 0 and −1 level curves. We begin with the 0 level curve. Let iεN. We want to know whether, below a certain bad value of this variable Rᵢ, it will no longer ever be possible to compensate for it entirely. We seek the value R_{i,#} of Rᵢ (if it exists) for which for all Rᵢ such that Vᵢ(Rᵢ)<Vᵢ(R_{i,#}) and for all R₋ᵢ, we have U(R)<0, and for which for all Rᵢ such that Vᵢ(Rᵢ)≧Vᵢ(R_{i,#}), there exists R₋ᵢ such that U(R)≧0. We therefore seek the value of Rᵢ with Vᵢ(Rᵢ) as negative as possible such that we still compensate entirely. We therefore seek:
Min{Vᵢ(Rᵢ), ∃ R₋ᵢ such that U(R)≧0}

We have U(R)≦Vᵢ (Rᵢ)+Σ_{jεN\i}Vⱼ*. Hence if U(R)≧0, then necessarily U(Rᵢ,Rᵢ*)≧0, where R₋ᵢ*=(R₁*, . . . , Rᵢ₋₁*, Rᵢ₊₁*, . . . ,Rₙ*). Hence, the above minimum equals:
Min{Vᵢ(Rᵢ), Vᵢ(Rᵢ)+Σ_{jεN\i}Vⱼ* ≧0}

If this minimum exists, then it is necessarily attained at Rᵢ=R_{i,#} satisfying:
Vᵢ(R_{i,#})+Σ_{jεN\i}Vⱼ*=0

It is easy to see that R_{i,#} may very well be equal to Rᵢ,**. Hence, Vᵢ(R_{i,#}) may attain the value Vᵢ,**. Hence Vᵢ(R_{i,#)≧V}ᵢ,**. By replacing this condition in the relation satisfied by R_{i,#}, we deduce therefrom that the minimum exists and is attained if and only if:
Vᵢ,**+Σ_{jεN\i}Vⱼ*≦0

If this condition does not hold, then we compensate entirely, even for infinite values of Rᵢ with Vᵢ(Rᵢ)≦0.

Case where Vᵢ,**+Σ_{jεN\i}Vⱼ*≦0 (with Vᵢ decreasing): this case is illustrated in FIG. 7.

Case where Vᵢ,**+Σ_{jεN\i}Vᵢ*>0 (with Vᵢ decreasing): this case is illustrated in FIG. 8.

We will now examine the characteristics of the −1 level curve. Let iεN. We wish to know whether, onward of a certain bad value of this variable Rᵢ, it will no longer ever be possible to compensate for it at least a little. We seek the value R_{i,$} of Rᵢ (if it exists) for which for all Rᵢ such that Vᵢ(Rᵢ)≦Vᵢ(R_{i,#}) and for all R₋ᵢ, we have U(R)≦−1, and for which for all Rᵢ such that Vᵢ(Rᵢ)>Vᵢ(R_{i,#}) there exists R₋ᵢ such that U(R)>−1. We therefore seek the value of Rᵢ with Vᵢ(Rᵢ) as negative as possible for which we no longer compensate at all. We therefore seek:
Max{Vᵢ(Rᵢ), such that U(R)≦−1, ∀R₋ᵢ}

We have U(R)≦Vᵢ(Rᵢ)+Σ_{jεN\i}Vⱼ*. Hence for U(R)≦−1 for all R₋ᵢ, it is necessary and sufficient that U(Rᵢ,R₋ᵢ*)≦−1. Hence the above maximum equals:
Max{Vᵢ(Rᵢ), Vᵢ(Rᵢ)+Σ_{jεN\i} Vⱼ*≦−1}

If this maximum exists, then it is necessarily attained at Rᵢ=R_{i,$} satisfying:
Vᵢ(R_{i,#})+Σ_{jεN\i} Vⱼ*=−1

It is easy to see that R_{i,$} may very well be equal to Rᵢ,**. Hence, we have: Vᵢ(R_{i,$})≧Vᵢ,**. By replacing this condition in the relation satisfied by R_{i,$}, we deduce therefrom that the minimum exists and is attained if and only if:
Vᵢ,**+Σ_{jεN\i}Vⱼ*≦−1

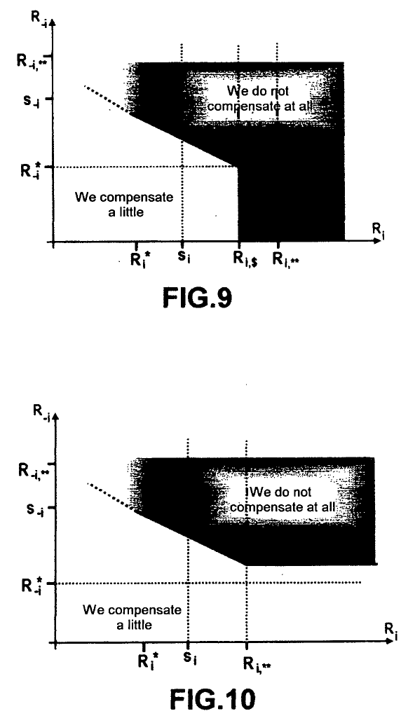

Case where Vᵢ,**+Σ_{jεN\i}Vⱼ*≦−1 (with Vᵢ decreasing): this case is illustrated in FIG. 9.

Case where Vᵢ,**+Σ_{jεN\i}Vⱼ*>−1: this case is illustrated in FIG. 10.

In the premises of the rules, the compensation terms are combined via min and max operators with other conditions. Thus, an unbounded behavior (that is to say with a level curve going to infinity) in the compensation may be bounded by other conditions. Confining ourselves to a single variable Rᵢ, there are three possible behaviors by combining the previous cases:

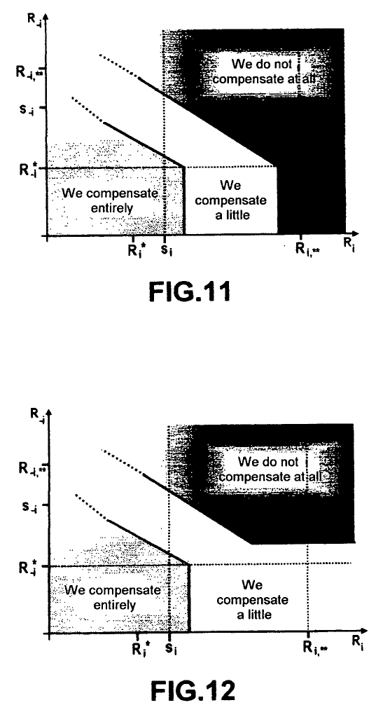

Case where Vᵢ,**+Σ_{jεN\i}Vⱼ*≦−1. For Vᵢ decreasing this gives the chart of FIG. 11.

Case where −1<Vᵢ,**+Σ_{jεN\i}Vⱼ*≦0. For Vᵢ decreasing this gives the chart of FIG. 12.

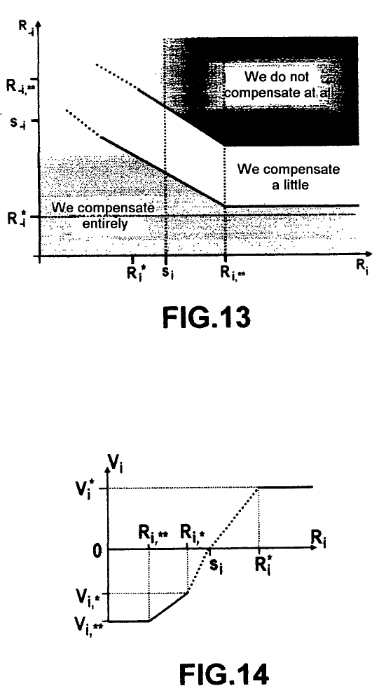

Case where 0<Vᵢ,**+Σ_{jεN\i}Vⱼ*−. For Vᵢ decreasing this gives the chart of FIG. 13.

We will now set forth the methodology of explanation of compensation according to the invention. We adopt the very general framework in which we have n variables denoted Rᵢ, . . . ,Rₙ. It will be recalled here that U(R₁, . . . ,Rₙ)=Σ_{iε{1, . . . ,n}}Vᵢ(Rᵢ). We compensate entirely if U(R₁, . . . ,Rₙ)≧0, and we no longer compensate at all if U(R₁, . . . ,Rₙ)≦−1.

For each iε{1, . . . ,n}, the utility function Vᵢ is assumed to be monotonic, that is to say either increasing, or decreasing. The sign of the derivative of Vᵢ is denoted εᵢ. We have εᵢ=1 if Vᵢ is increasing, and εᵢ=−1 if Vᵢ is decreasing. We assume that the compensation pertains to the alternative CₘεC.

In the introduction of compensation, several compensation situations may be possible. In the example cited above (in regard to the introduction of compensation into a decision tree), the compensation introduced is of the type:
R₁ compensates for R₂

This corresponds to the case where the variable R₁ is more important than R₂. In the case where no variable is dominant, both directions of compensation could have been possible:
(R₁ compensates for R₂) OR (R₂ compensates for R₁)

We therefore see that several compensation situations may be permitted jointly. In the general case, we assume that the expert permits a certain number (denoted t) of possible compensation situations:
(the variables of A⁺₁ compensate for the variables of A⁻₁) OR . . .
OR (the variables of A⁺ₜ compensate for the variables of A⁻ₜ)

For all pε{1, . . . ,t}, we have A⁺ₚ∩A⁻ₚ=Ø and A⁺ₚ∪A⁻ₚ={1, . . . ,n}. Stated otherwise, a variable cannot, in one and the same compensation situation, be both compensated and compensating. Moreover, in any compensation situation whatsoever, every variable is either compensated or compensating. We denote by I={(A⁺₁,A⁻₁), . . . ,(A⁺ₜ, A⁻ₜ)} the set of pairs of permitted compensations. The set of variables which compensate for others equals:
I⁺={iε{1, . . . ,n}/∃(A⁺,A⁻)εI such that iεA⁺}

The set of variables which are compensated by others equals:
I=⁻=iε{1, . . . ,n}/∃(A⁺,A⁻)εI such that iεA⁻}

For iεI⁻, we write I⁺(i)={jεI⁻/∃(A⁺,A⁻)εI such that iεA⁻ and jεA⁺} and I⁻(i)={jεI⁺/∃(A⁺,A⁻)εI such that iεA⁻ and jεA⁺}.

All the compensation situations are modeled in a unique global utility function U(R₁, . . . ,Rₙ)=Σ_{iε{1, . . . ,n}} Vᵢ(Rᵢ). To specify U(R) in the compensation situations of I, it suffices to determine the positive part of Vⱼ for all jεI⁺, and the negative part of Vᵢ for all iεI⁻. Nevertheless, since we are in a fuzzy logic context, compensation will necessarily be allowed at least a little outside of the compensation situations such as they have been defined by the expert. This shows that U(R) will have to be defined for all R, and hence that the positive and negative parts of Vᵢ must be specified for all iε{1, . . . ,n}. However, the expert will not be capable of actually specifying the compensation outside of the compensation situations that he has defined. We will therefore ask for the minimum information possible in these zones.

For each iεN, we want to know to which case out of those described above (in regard to the typical compensation behaviors) the variable Rᵢ corresponds. Let us recall that these cases describe the behavior of the level curves for the bad values of the variable Rᵢ. For iεI⁻, we pose the question:

Out of the following three possible behaviors, which one corresponds to Rᵢ?

We have the following three possible answers R1 to R3:
R1: There exists a value of Rᵢ above (if εᵢ=1)/below (if εᵢ=−1) which no more compensation is possible regardless of the value along the other variables.
R2: Regardless of the value Rᵢ (even very bad) , we compensate entirely in respect of sufficiently good values of the other variables.
R3: There exists a value of Rᵢ above (if εᵢ=1)/below (if εᵢ=−1) which we no longer compensate entirely regardless of the value along the other variables. Moreover, regardless of the value of Rᵢ (even very bad), we always compensate at least a little in respect of sufficiently good values of the other variables.

We denote by [symbol] ₁ the set of values of i belonging to the case R1. We denote by [symbol] ₂ the set of values of i belonging to the case R2. We denote by 3 the set of values of i belonging to the case R3.

As already mentioned previously, the utility functions are characterized by the fact that they have a minimum value, a maximum value, and that they pass through the zero level. We may therefore limit ourselves to determining these three characteristic points.

When iε [symbol] ₁, the shape of the utility function is a little more complex. It comprises two negative levels Vᵢ,* and Vᵢ,**. In order to be able to give a rigorous definition of Rᵢ,** referring to Vᵢ,**, we confine ourselves to compensation situations I such as they are defined by the expert. We recall that Vᵢ,** satisfies the relation Vᵢ,**+Σ_{jεN\i} Vⱼ*≦−1. Now, the expert is concerned with the compensation situations such as he has defined them, in which the variable Rᵢ appears. This involves pairs (A⁺,A⁻)εI such that iεA⁻. It is therefore necessary to satisfy the relation Vᵢ,** +Σ_{jεA+}Vⱼ≦−1 for all (A⁺,A⁻)εI such that iεA⁻. Moreover, in order to be able to define Rᵢ,**₁ very accurately, we impose the need for the relation Vᵢ,**+Σ_{jεA+}Vⱼ*≦−1 to be satisfied with an equality for a pair (A⁺,A⁻)εI with iεA^{-. Unfortunately, it is not possible to satisfy this constraint and the relation V}ᵢ,** +Σ_{jεN\i} Vⱼ*≦−1 at the same time. To resolve this difficulty, we introduce two negative levels Vᵢ,* and Vᵢ,**. Let Rᵢ,* be the value of the variable Rᵢ corresponding to the utility Vᵢ,* : Vᵢ,*=Vᵢ(Rᵢ,*). The value Vᵢ,** satisfies the relation Vᵢ,** +Σ_{jεN\i} Vⱼ*=−1, so that Rᵢ,** has a clear and precise definition outside of the compensation framework. The value Vᵢ,* satisfies the relation Vᵢ,**+Σ_{jεA+}Vⱼ*≦−1 for all (A⁺,A⁻)εI such that iεA⁻ (one of these inequalities corresponding to an equality), so that Rᵢ,* has a clear and precise definition referring to the case of the compensation situations defined by the expert. The curve of FIG. 14 gives the profile of the utility functions when they are increasing (εᵢ=1).

In the case where i belongs to [symbol] ₂ or [symbol] ₃, there is no need to introduce Rᵢ,* and Vᵢ,*. Nevertheless, in what follows, we will refer to the values Rᵢ,* and Vᵢ,* when we are in the compensation situations of I. By uniformity, we also define Rᵢ,* and Vᵢ,* in the case where i belongs to [symbol] ₂ or [symbol] ₃. In this case, we write Rᵢ,*=Rᵢ,** and Vᵢ,* =Rᵢ,**.

We have for all iε [symbol] ₁:
∀(A⁺,A⁻)εI such that iεA⁻, we have Vᵢ,*+Σ_{jεA+}Vⱼ* ≦−1

We have for all iΕ [symbol] ₂:
∃(A⁺,A⁻)εI such that iεA⁻, we have 0<Vᵢ,*+Σ_{jεA+}Vⱼ*

The case R3 is the complement of the union of the first two cases. We have for all iΕ [symbol] ₃:
∃(A⁻,A⁻)εI such that iεA⁻, we have Vᵢ,* +Σ_{jεA-}Vⱼ*>−1
∀(A⁺,A⁻)εI such that iεA⁻, we have Vᵢ,*+Σ_{jεA+}Vⱼ*≦0

We will now examine the case of the reply R1 alone. We assume here that for all i, we have iε [symbol] ₁.

Firstly, we will examine the utility functions determined at the extremities. In this part we limit ourselves to the determination, for all i, of the characteristic points sᵢ, Rᵢ*, Rᵢ,*, Rᵢ,** and their utility. We assume that the utility functions are either simply affine or given by the expert between these points. The expert will be posed questions relating to the two level curves “we compensate entirely” and “we do not compensate at all” concerning these characteristic points only. We assume that the expert will be capable of explaining alone the remainder of the utility functions, that is to say their behavior between the characteristic points.

We must therefore determine for every i, the seven notable values sᵢ, Rᵢ*, Rᵢ,*, Rᵢ,**, Vᵢ*, Vᵢ,* and Vᵢ,**. To do this, we shall base ourselves on the consequences of these values, that is to say the possibility of the alternative deriving from U. Nevertheless, it will not be at all easy for an expert to be able to provide, from the value of the variables, directly the degree of possibility regarding the alternative deriving from U. On the other hand, he will be capable of saying whether the alternative Cₘ is entirely possible or whether it is impossible. Stated otherwise, the determination of the parameters may be done based on notable points of the 0 level curve (the alternative Cₘ is entirely possible) and −1 level curve (the alternative Cₘ is impossible) of U.

We will here list the particular points of the two level curves, 0 and −1, of U that make it possible to enable the parameters to be determined.

Let (A⁺,A⁻)εI, iεA⁺ and A⊂A⁺. We define the vector of variables R_{i,A}⁻(Rᵢ) by: (R_{i,A}⁻(Rᵢ))ᵢ=Rᵢ, (R_{i,A}⁻(Rᵢ))ₖ=sₖ for kεA⁻\i and for kεA⁺\A, and (R_{i,A}⁻(Rᵢ))ₖ=Rₖ* for kεA. According to this definition, for Rᵢ lying between Rᵢ,* and sᵢ, the variables of A⁺ are good while the variables of A⁻ are bad. Hence, the variables in A⁺ do indeed compensate for the variables of A⁻. We have the compensation such as it is desired by the expert. We have:
U(R_{i,A}⁻(Rᵢ))=Vᵢ(Rᵢ)+Σ_{kεA}Vₖ*

For Rᵢ=sᵢ, we have U ( R_{i,A}⁻(sᵢ))=ΣkεA Vₖ*≧0. For Rᵢ=Rᵢ,*, as the compensation is of the type R1, we have:
U( R_{i,A}⁻(Rᵢ, *))=Vᵢ,* +Σ_{kεA V}ₖ*≦Vᵢ,* +Σ_{kεA+}Vₖ*≦−1

Hence, by continuity of the utility function Vᵢ, there exists Rᵢ lying between Rᵢ,* and sᵢ such that U(R_{i,A}⁻(Rᵢ))=0. This is the smallest (if εᵢ=1)/largest (if εᵢ=−1) value of Rᵢ for which the alternative Cₘ deserves entirely to be allocated to the point R_{i,A}⁻(Rᵢ). Moreover, there exists Rᵢ lying between Rᵢ,* and sᵢ such that U(R_{i,A}⁻(Rᵢ))=−1. This is the largest (if εᵢ=1)/smallest (if εᵢ=−1) value of Rᵢ for which the alternative Cₘ is completely impossible for the point R_{i,A}⁻(Rᵢ).

An interesting particular case occurs when A=Ø. In this case, we have: U(R_{i,Ø}⁻(Rᵢ))=Vᵢ(Rᵢ). Therefore U(R_{i,Ø}⁻(sᵢ))=0.

Within the framework of the determination of the parameters, and to avoid the effects of thresholds, we must determine U, not only for all the possible values of the variables within the framework of compensation, but for all the possible values of the variables even outside of the framework of compensation. Nevertheless, insofar as possible, we will have to ask the expert only questions relating to values situated within the framework of compensation.

We determine the utility functions as and when required. While the algorithm is running, we denote by D⁺ the set of variables Rⱼ for which the positive part of the utility function Vⱼ is determined, and by D⁻ the set of variables Rᵢ for which the positive part of the utility function Vᵢ is determined. At the start of the algorithm, we have D⁺=Øand D⁻=Ø.

We now give the details of the algorithm. The steps are numbered by a label always beginning with C1-R1. The title C1 signifies that we are in case 1 (that is to say we determine the utility functions only of the extremities) while R1 signifies that all the variables are assumed to belong to the compensation framework R1.

The method of the invention is composed of the following steps:

C1-R1-1—Definition of the reference thresholds s₁, . . . ,sₙ: The reference thresholds S₁, . . . ,Sₙ correspond to the level which makes it possible to compensate entirely, but only just, as regards the variables R₁, . . . ,Rₙ. To determine sᵢ, the expert answers the following question:
Q1 [C1-R1]: What is the value that makes it possible to allocate the alternative Cₘ entirely, but only just, according to the variable Rᵢ alone?

Another possible question would be:
Q1′ [C1-R1]: What is the value that makes it possible to allocate the alternative Cₘ entirely, but only just, as regards the variable Rᵢ, if the other thresholds are fixed at the same level of satisfaction?We must have:
   Vᵢ(sᵢ)=0 (1-[C1-R1])

C1-R1-2—Definition of the values Rⱼ* for jεI⁺: Onward of (if εⱼ=1)/below (if εⱼ=−1)Rⱼ*, the utility function Vⱼ remains stuck at the value Vⱼ* and makes no further progress. To determine Rⱼ*, the expert answers the following question:
Q2 [C1-R1]: Onward of (if εⱼ=1)/below (if εⱼ=−1) what value of Rⱼ does this variable no longer compensate further for the variables of I⁻(j) in the allocation of the alternative Cₘ?

We must have εⱼ×Rⱼ,*≧εⱼ×Rⱼ,♦, or Rⱼ,♦ is defined above (in regard to the methodology of explanation of fuzziness in a noncompensatory condition).

C1-R1-3—Definition of the values Rₖ,* for kεI⁻: Within the framework of a compensation of the type R1, Rₖ,* is the value of Rₖ below which no compensation will be possible, regardless of the value along the other variables (in a compensation situation of I). This implies that we should not compensate at all when Rₖ=Rₖ,* for the best possible values along the other variables, within the framework of compensation. Here we shall recall the condition given previously for R1:
∀(A⁺A⁻)εI with kεA⁻, Vₖ,* +Σ_{jεA+}Vⱼ* ≦−1. (2-[C1-R1])

To determine Rₖ,*, the expert answers the following question:
Q3 [C1-R1]: Below (if εₖ=1)/onward of (if εₖ=−1) what value of Rₖ do you want to no longer compensate at all, regardless of the value along the other variables (with values corresponding to a compensation situation)?

Another possible question would be:

Q3′ [C1-R1]: Up to (if εₖ=1)/onward of (if εₖ=−1) what value of Rₖ does the alternative Cₘ no longer deserve to be envisaged (with values corresponding to a compensation situation)?

We must have εₖ×Rₖ*≦εₖ×Rₖ♦, where Rₖ♦ is defined hereinabove (in regard to the methodology of explanation of fuzziness in a noncompensatory condition). According to this definition, Rₖ* is the limit value of the compensation. Hence, in (2-[C1-R1]), we must have equality for a pair (A⁺,A⁻).

C1-R1-4—Determination of the utility function Vₖ between Rₖ,* and sₖ for kεA⁻: At this stage, the value of Vₖ,* is still not specified. On the other hand, according to equation (1-[C1-R1]), we know that Vₖ corresponds to a ratio scale. The objective of this phase is to be specify Vₖ in the guise of ratio scale, that is to say to determine λₖ(Rₖ)=Vₖ(Rₖ)/Vₖ,*. This number lies between 0 and 1 for Rₖ lying between Rₖ,* and sₖ. To determine λₖ(Rₖ), we use a procedure arising out of measure theory. The invention provides for the MACBETH methodology (cf. C. Bana e Costa & J. C. Vansnick, Applications of the MACBETH approach in the framework of an additive aggregation model, Journal of Multicriteria Decision Analysis, No. 6, pp. 107-114, 1997). Nevertheless, any other methodology making it possible to determine utility functions is also suitable. In the simplest case, λₖ is simply affine:
λₖ(Rₖ)=(sₖ-Rₖ)/(sₖ-Rₖ,*).

C1-R1-5—Determination of the utility function Vⱼ between sⱼ and Rⱼ* for jεA⁺: We proceed exactly as in the previous phase. We therefore determine with the help of a procedure arising out of measure theory the value of λⱼ(Rⱼ)=Vⱼ(Rⱼ)/Vⱼ*. This number lies between 0 and 1 for Rⱼ lying between sⱼ and Rⱼ*. In the simplest case, λⱼ is simply affine: λⱼ(Rⱼ)=(Rⱼ-sⱼ)/(Rⱼ*-sⱼ).

C1-R1-6—Determination of iεI⁻\D⁻ of reference: The questionnaire will be based on a particular variable from I^{-\D}⁻. The objective of this step is to determine this index. It is the most important variable among those which are compensated (in I^{-\D}⁻). The compensation that we describe generally pertains chiefly to one variable. This is the variable that we are seeking. To determine iεI⁻, the expert answers the following question:
Q4 [C1-R1]: Which out of the remaining variables that are compensated (that is to say I^{-\D}⁻) is the most important, the one that the questionnaire will be based on?

C1-R1-7—Determination of Vᵢ,* and of Vⱼ* for all jεI⁺(i)\D⁺: Let jεI⁺(i)\D⁺. Let (A⁺,A⁻)εI such that iεA⁻ and jεA⁺. We will use a singular point defined hereinabove (in regard to the particular points on the two level curves). We consider the vector of variables R_{i,j}⁻(Rᵢ) defined previously with the sets A⁺ and A⁻. R_{i,j}⁻(Rᵢ) corresponds R_{i,A}⁻(Rᵢ) when A={j}. The vector of variables R_{i,j}⁻(Rᵢ) is defined by: (R_{i,j}⁻(Rᵢ))ᵢ=Rᵢ, (R_{i,j}⁻(Rᵢ))ⱼ=Rⱼ*, and (R_{i,j}⁻(Rᵢ))ₖ=sₖ for kεN\{i,j}. We therefore see that R_{i,j}⁻(Rᵢ) is independent of A⁺ and A⁻. We saw above (again with regard to the particular points), that there exists Rᵢ lying between Rᵢ,* and sᵢ such that U(R_{i,j}⁻(Rᵢ))=0. This value is denoted R_{i,j}⁰. It is independent of A⁺ And A⁻. It is the smallest (if εᵢ=1)/largest (if εᵢ=−1) value of Rᵢ such that the alternative Cₘ deserves entirely to be allocated to the point R_{i,j}⁻(Rᵢ). To determine R_{i,j}⁰, the expert answers the following question:
Q5[C1-R1]: For Rₖ fixed at sₖ for k≠i,j, onward of (if εᵢ=1)/up to (if εᵢ=−1) what value of Rᵢ do you think that the variable Rⱼ=Rⱼ* compensates entirely for Rᵢ?

As R_{i,j}⁻(R_{i,j}⁰))=0, we must have:
Vⱼ*+λᵢ(R_{i,j}⁰) Vᵢ,* =0 (3-[C1-R1])

We write, according to equation (3-[C1-R1]), Vⱼ* as a function of Vᵢ,*. By placing this in (2-[C1-R1]), we obtain
(1−Σ_{jεA+∩D+}λᵢ(R_{i,j}⁰)) Vᵢ,* +Σ_{jεA+⊂D+V}ⱼ*≦−1.

We cannot be in the compensation case R1 if 1-Σ_{jεA+\D+}λᵢ(R_{i,j}⁰)≦0. We therefore assume here that 1-Σ_{jεA+\D+}λᵢ(R_{i,j}⁰)>0. In the converse case, the information provided is inconsistent. Vᵢ,* therefore satisfies:
Vᵢ,*≦−(1+Σ_{jεA+∩D+}Vⱼ*)/(1−Σ_{jεA+}λᵢ(R_{i,j}⁰))

This relation must be satisfied for all (A⁺,A⁻)εI such that iεA⁻. We therefore obtain:
Vᵢ,* ≦Λ_{(A+,A-)εI/iεA-}−(1+Σ_{jεA+∩D+}Vⱼ*)/(1-Σ_{jεA+}λᵢ(R_{i,j}⁰))
where the operator A designates the minimum.

In order for Rᵢ,* to actually correspond to the largest (if εᵢ=1)/smallest (if εᵢ=−1) value of Rᵢ which we no longer compensate at all, the previous relation must be considered with an equality. This signifies that the relation Vᵢ,* +Σ_{jεA+}Vⱼ*≦−1 will be satisfied with an equality for a pair (A⁺,A⁻). Hence:
Vᵢ,*=Λ_{(A+A-)εI/iεA-}−(1+Σ_{jεA+∩D+}Vⱼ*)/(1−Σ_{jεA+}λᵢ(R_{i,j}⁰)) (4-[C1-R1])

From this we deduce with (3-[C1-R1]) the expression for Vⱼ* for all jεI⁺(i)\D⁺:
Vⱼ*=−λᵢ(R_{i,j}⁰)×Λ_{(A+,A-)εI/iεA-}−(1+Σ_{jεA+∩D+}Vⱼ*)/(1-Σ_{jεA+}λᵢ(R_{i,j}⁰)) (5-[C1-R1])

We add the variable i to the set D⁻ and the set I⁺ (i)\D⁺ to D⁺.

C1-R1-8—Determination of Vₖ,* for kεI⁻\D⁻ such that I⁺(k)⊂D⁺: For all kεI⁻\D⁻ such that I⁺(i)⊂D⁺, we have according to (2-[C1-R1]), regardless of (A⁺,A⁻)εI with kεA⁻, we have:
Vₖ,*≦−1−Σ_{jεA+}Vⱼ*
hence:
Vₖ,*≦Λ_{(A+,A-)εI/kεA-}−1−Σ_{jεA+}Vⱼ*

As previously, the previous relation must be considered with an equality. We therefore have kεI⁻\D⁻ such that I⁺(i)⊂D⁺:
Vₖ,*=Λ_{(A+,A-)εI/kεA-}−1−Σ_{jεA+}Vⱼ* (6-[C1-R1])

We add the variables kεI⁻\D⁻ such that I⁺(k)⊂D⁺ to the set D⁻. If D⁻≠I⁻, we return to step C1-R1-6. If D⁻=I⁻, then necessarily we have D⁺=I⁺.

C1-R1-9—Determination of Vⱼ* for a j∉I⁺: The variable Rⱼ for j∉I⁺ is never presumed to compensate for other variables, according to the possible compensations fixed by the user. Nevertheless, to avoid the threshold effects, it is indeed necessary for all the compensations to be defined. To determine Rⱼ*, we ask the expert a question much like the question Q2[C1-R1]:
Q6 [C1-R1]: Up to (if εⱼ=1)/onward of (if ε=−1) what value of Rⱼ can this variable no longer compensate any further for the other variables in the allocation of the alternative Cₘ?

We will not ask the expert a question of the type Q5[C1-R1] to determine Vⱼ*. We want to determine a value of Vⱼ* without asking a question, less it be empirical. The expert will not be capable of reasoning in these zones, and hence of answering a precise question of the type Q5[C1-R1]. The exact value of the compensation in these zones is of lesser importance.

As this variable is not presumed to compensate for others, the manner in which it will compensate for the others will necessarily be of small amplitude, that is to say it will compensate less than the variables that are presumed to compensate:
Vⱼ*<Λ_{kεI+}Vₖ*.

We can for example:
Vⱼ* =Λ_{kεI+}Vₖ*/2.

C1-R1-10—Determination of Vₖ beyond Rₖ,* for kεI⁻: To determine Rₖ,**, we ask the expert a question much like the question Q3 [C1-R1]:
Q7 [C1-R19 : Below (if εₖ=1)/onward of (if εₖ=−1) what value of Rₖ do you no longer want to compensate at all, regardless of the value along the other variables (with values outside of the framework of compensation)?

To determine the extent to which the compensation should occur in the permitted compensation zones, it suffices to know Vₖ between sₖ and Rₖ*. The values of Rₖ,** and Vₖ,** have no influence in the zones where compensation is permitted. According to the definition of Rₖ,**, Vₖ,** must satisfy the relation:
Vₖ,**+Σ_{j≠k}Vⱼ*=−1

We therefore obtain:
Vₖ,** =−1−Σ_{j≠k}Vⱼ* (7-[C1-R1])

C1-R1-11—Determination of Rₖ,* and of Vₖ,* for k∉I⁻:

For k∉I⁻, the variable Rₖ is never presumed to be compensated by other variables. To determine Rₖ,* and Vₖ,*, we proceed as in the previous step. To determine Rₖ,*, we ask the expert a question much like the question Q3 [C1-R1]:
Q8 [C1-R1]: Below (if εₖ=1)/onward of (if εₖ=−1) what value of Rₖ do you no longer want to compensate at all, regardless of the value along the other variables?

According to the definition of Rₖ,*, we obtain, as previously, for Vₖ,* the following expression:
Vₖ,*=−1−Σ_{j≠k}Vⱼ* (8-[C1-R1])

At the end of steps C1-R1-7 and C1-R1-8, the construction certifies that the condition Vᵢ,*+Σ_{jεA+}Vⱼ*≦−1 is indeed satisfied for all (A⁺,A⁻)εI such that iεA⁻.

Once the parameters have been calculated, we can validate them with reference to the notable points. Let: (A⁺,A⁻)εI. We then examine the various cases of vectors of variables.
Vector of variables R_{k,Ø}⁻ for kεA^{-. According to the above explanations relating to the particular points on the two level curves; there exists a value R}_{k,ø}⁻¹ of the variable Rₖ such that U(R_{k,Ø}⁻(R_{k,Ø}⁻¹))=−1. As U(R_{k,Ø}⁻(R_{k,Ø}⁻¹))=Vₖ(Rₖ), we have:
   R_{k,Ø}⁻¹=Vₖ⁻¹(−1)

R_{k,Ø}⁻¹ is interpreted in the following manner:
Up to (if εₖ=1)/onward of (if εₖ=−1) the value R_{k,Ø}⁻¹ of the variable Rₖ, the variables Rₚ=sₚ for pεA⁺no longer compensate at all for Rₖ and Rₚ=sₚ for pεA⁻\{i}.

This may also be stated as follows:
Up to (if εₖ=1)/onward of (if εₖ=−1) the value R_{k,Ø}⁻¹ of the variable Rₖ, the alternative Cₘ is impossible when the other variables are at the level of the threshold sₚ.

If the expert is not in agreement with the value of R_{k,Ø}⁻¹, we set λₖ (R_{k,Ø}⁻¹)=−1/Vₖ,* for the value R_{k,Ø}⁻¹ that the expert thinks is correct.
Vector of variables R_{k,j}⁻ for kεA⁻\{i} and jεA⁺. According to the same explanations as regards the particular points, there exists a value R_{k,j}⁻¹ of the variable Rₖ such that U(R_{k,j}⁻(R_{k,j}⁻¹))=−1. As U(R_{k,j}⁻(R_{k,j}⁻¹))=Vₖ(Rₖ)+Vⱼ*, we have:
   R_{k,j}⁻¹=Vₖ⁻¹(−1−Vⱼ*)

R_{k,j}⁻¹ is interpreted in the following manner:
Up to (if εₖ=1)/onward of (if εₖ=−1) the value R_{k,j}⁻¹ of the variable Rₖ, the variables Rₖ=Rₖ* and Rₚ=sₚ for pεA⁺\{j} no longer compensate at all for Rₖ and Rₚ=sₚ for pεA⁻\{i}.

This may also be stated in the following manner:
Up to (if εₖ=1)/onward of (if εₖ=−1) the value R_{k,j}⁻¹ of the variable Rₖ, the alternative Cₘ is impossible when the other variables are at the level of the threshold sₚ, except the variable Rⱼ=Rⱼ*.

If the expert is not in agreement with the value of R_{k,j}⁻¹, we set λₖ(R_{k,j}⁻¹)=−(1+Vⱼ*)/Vₖ,* for the value R_{k,j}⁻¹ that the expert thinks is correct.
Vector of variables R_{k,j}⁻ for kεA⁻\{i} and jεA⁺. According to the same explanations as regards the particular points, there exists one value R_{k,j}⁰ of the variable Rₖ such that U(R_{k,j}⁻(R_{k,j}⁰))=0. We have:
   R_{k,j}⁰=Vₖ⁻¹(−Vₖ*)

R_{i,j}⁰ is interpreted in the following manner:
Onward of (if εₖ=1)/below (if εₖ=−1) the value R_{k,j}⁻¹ of the variable Rₖ, the variables Rₖ=Rₖ* and Rₚ=sₚ for pεA⁺\{j} compensate entirely for Rₖ and Rₚ=sₚ for pεA⁻\{i}.

This may also be stated in the following manner:
Onward of (if εₖ=1)/below (if εₖ=−1) the value R_{k,j}⁻¹ of the variable Rₖ, the alternative Cₘ is entirely possible when the other variables are at the level of the threshold sₚ, except the variable Rⱼ=Rⱼ*.

If the expert is not in agreement with the value of R_{k,j}⁻⁰, we set λₖ(R_{k,j}⁰)=−Vⱼ*/Vₖ,* for the value R_{k,j}⁻⁰ that the expert thinks is correct.

We will now examine the utility functions determined at every point for I⁺ and I⁻. The hypothesis made above in regard to the utility functions determined at the extremities is that the expert is capable of explaining the utility functions between the extreme values which themselves are determined by the methodology. Thus, in accordance with steps C1-R1-4 and C1-R1-5 described hereinabove, the expert must be capable of providing λᵢ(Rᵢ) for all Rᵢ. This is arguable given the implications that the values of λᵢ have on the level curves. It is classical to consider the utility functions as piecewise affine functions. It may then seem desirable that the methodology should make it possible to determine the levels Vᵢ(Rᵢ) of each point Rᵢ by delimiting two affine parts.

In this section, we assume that the expert is not capable of determining λᵢ(Rᵢ) between the two extremities for iεI⁻ or iεI⁺.

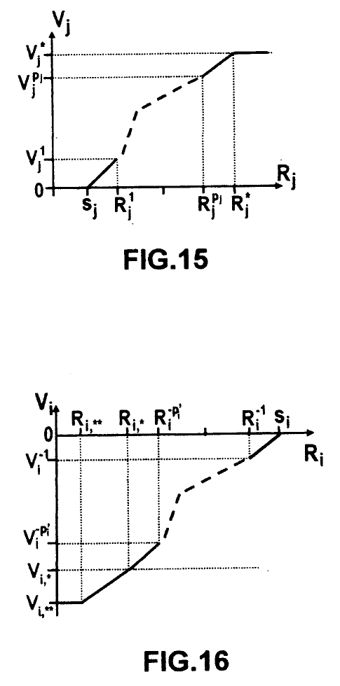

For jεI⁺, we assume that the expert is capable of providing the relevant intermediate points between sⱼ and Rⱼ*. We write Rⱼ¹, . . . , Rⱼ^{pj} for these pⱼ points, and Vⱼ^{k}=Vⱼ(Rⱼ^{k}) for kε{1, . . . ,pⱼ}, as represented in FIG. 15.

We write Rⱼ⁰=sⱼ, Vⱼ⁰=0, Rⱼ^{pj+1}=Rⱼ* and Vⱼ^{pj+1}=Vⱼ*. For kε{0, . . . ,pⱼ} and Rⱼε[Rⱼ^{k}, Rⱼ^{k+1}], we have Vⱼ(Rⱼ)=Vⱼ^{k}+(Vⱼ^{k+1}−Vⱼ^{k})λⱼ^{k}(Rⱼ) where λⱼ^{k}(Rⱼ)=(Rⱼ−Rⱼ^{k})/(Rⱼ^{k+1}−Rⱼ^{k}).

For iεI⁻, we assume that the expert is capable of providing the relevant intermediate points between Rᵢ,* and sᵢ. We write Rᵢ⁻¹, . . . , Rᵢ^{-p′i} for these p′i points, and Vᵢ^{k}=Vᵢ(Rᵢ^{k}) for kε{−p′ᵢ, . . . ,−1}. We write Rᵢ⁰=sᵢ, Vᵢ⁰=0, Rᵢ^{-p′i-1}=Rᵢ,* and Vᵢ^{-p′i-1}=Vᵢ,*. For all kε{−p′ᵢ−1, . . . ,−1} and all Rᵢε[Rᵢ^{k}, Rᵢ^{k+1}], we have Vᵢ(Rᵢ)=Vᵢ^{k}+(Vᵢ^{k+1}−Vᵢ^{k})λᵢ^{k}(Rᵢ) where λᵢ^{k}(Rᵢ)=(Rᵢ−Rᵢ^{k})/(Rᵢ^{k+1}−Rᵢ^{k}). The utility function is affine in each segment (Rᵢ^{k}, Rᵢ^{k+1}], as represented in the curve of FIG. 16. Here we seek, according to the 0 and −1 level curves, to determine Vᵢ⁻¹, . . . , Vᵢ^{-p′i}, Vᵢ,* for iεI⁻, and Vⱼ*, Vⱼ¹, . . . , Vⱼ^{pj} for jεI⁺.

We will list the particular points of the two 0 and −1 level curves of U that make it possible to enable the parameters to be determined. Let (A⁺,A⁻)εI.

Let K be a set of indices kⱼ for jεA⁺, with kⱼε{0, . . . ,pⱼ+1}. Let iεA⁻ and K={kⱼ}_{jεA+}. We define the vector of variables Rᵢ^{K-}(Rᵢ) by: (Rᵢ^{K (R}ᵢ))ᵢ=Rᵢ, (Rᵢ^{K-}(Rᵢ))_{q}=s_{q} for qεA⁻\i, and (Rᵢ^{K-}(Rᵢ))_{q}=R_{q}^{kq} for qεA⁺.

We have:
U(Rᵢ^{K-}(Rᵢ)=Vᵢ(Rᵢ)+Σ_{jεA+}Vⱼ^{kj}

For Rᵢ=sᵢ, it follows that:
U(Rᵢ^{K-}(sᵢ))=Σ_{jεA+}Vⱼ^{kj}≧0.

For Rᵢ=Rᵢ,*, as the compensation is of the type R1, we have:
U(Rᵢ^{K-}(Rᵢ,*))=Vᵢ,* +Σ_{jεA+}Vⱼ^{kj}≦Vᵢ,*+Σ_{kεA+V}ₖ*≦−1

Hence, by continuity, there exists Rᵢ lying between sᵢ and Rᵢ,* such that U(Rᵢ^{K-}(Rᵢ))=0. We write Rᵢ^{K,0} for this point. This is the smallest (if εᵢ=1)/largest (if εᵢ=−1) value of Rᵢ for which the alternative Cₘ deserves entirely to be allocated to the point Rᵢ^{K-} (Rᵢ). We have:
Vᵢ(Rᵢ^{K,0})+Σ_{jεA+}Vⱼ^{kj}=0

Moreover, there exists Rᵢ lying between sᵢ and Rᵢ,* such that U(Rᵢ^{K-}(Rᵢ))=−1. We write Rᵢ^{K,-1} for this point. This is the largest (if εᵢ=1)/smallest (if εᵢ=−1) value of Rᵢ for which the alternative Cₘ is completely impossible for the point R_{i,A}⁻(Rᵢ). We have:
Vᵢ(Rᵢ^{K,-1)+Σ}_{jεA+}Vⱼ^{kj}=−1

Let kᵢε{−p′ᵢ−1, . . . ,−1}, and consider a set of indices kⱼ for jεA⁺\{j}, with kⱼε{0, . . . ,pⱼ+1}. We now define another notable point. Let iεA⁻, jεA⁺ and K={kⱼ}_{jεi∪A+\j}. We define the vector of variables R_{i,j}^{K+}(Rⱼ) by: (R_{i,j}^{K+}(Rⱼ))ⱼ=Rⱼ, (R_{i,j}^{K+}(Rⱼ))_{q}=s_{q} for qεA⁻\i, and (R_{i,j}^{K+}(Rⱼ))_{q}=R_{q}^{kq} for qεi∪A⁺\j. We have:
U(R_{i,j}^{K+}(Rⱼ))=Vⱼ(Rⱼ)+Vᵢ^{ki}+Σ_{qεA+\j}V_{q}^{kq}

In contradiction to the previous notable point, it is not definite that when Rⱼ describes the interval lying between sⱼ and Rⱼ* then U(R_{i,j}^{K+}(Rⱼ)) cuts one of the two 0 or −1 level curves. We will study the conditions under which there is intersection. To do this, let K⁰ be the index set defined on A⁺ by (K⁰)_{q}=k_{q} if qεA⁺\j and (K⁰)ⱼ=0. We write Rᵢ^{K0,0} and Rᵢ^{K0,-1} for the notable points of the vector of variables Rᵢ^{K0,-} defined previously on the basis of K⁰. Let K* be the index set defined on A⁺ by (K*)_{q}=k_{q} if qεA⁺\j and (K*)ⱼ=pⱼ+1. We write Rᵢ^{K*,0} and Rᵢ^{K*,-1} for the notable points of the vector of variables Rᵢ^{K*,-} defined previously on the basis of K*. Finally, consider the vector of variables R_{i,j}^{K}(Rᵢ,Rⱼ) by: (R_{i,j}^{K}(Rᵢ,Rⱼ))ᵢ=Rᵢ, (R_{i,j}^{K}(Rᵢ,Rⱼ))ⱼ=Rⱼ, (R_{i,j}^{K}(Rᵢ, Rⱼ))_{q}=s_{q} for qεA⁻\i, and (R_{i,j}^{K}(Rᵢ,Rⱼ))_{q}=R_{q}^{kq} for qεA⁺\j. We have:
U(R_{i,j}^{K}(Rᵢ, Rⱼ))=Vᵢ(Rᵢ)+Vⱼ(Rⱼ)+Σ_{qεA+\j}V_{q}^{kq}

We have the following cases:
If εᵢ×Rᵢ<εᵢ×Rᵢ^{K*,-}, then for all Rⱼε[Rⱼ*,sⱼ], we have, as Vᵢ is increasing (if εᵢ=1)/decreasing (if εᵢ=−1) and according to the definition of Rᵢ^{K*,-}:
   Vᵢ (Rᵢ)<Vᵢ(Rᵢ^{K*,-})=−1−Vⱼ*−Σ_{qεA+\j}V_{q}^{kq}
   Hence:
   U(R_{i,j}^{K}(Rᵢ,Rⱼ))≦Vᵢ(Rᵢ)+Vⱼ* +Σ_{qεA+\j}V_{q}^{kq}<−1
From this we deduce that the level curve U(R_{i,j}^{K}(Rᵢ,Rⱼ))=−1 does not pass through the rectangle εᵢ×Rᵢ<εᵢ×Rᵢ^{K*,-}, Rⱼε[sⱼ,Rⱼ*].
Let εᵢ×Rᵢ^{K*,-}≦εᵢ×Rᵢ≦εᵢ×Rᵢ^{K0,-}. Then Vᵢ(Rᵢ^{K*,-})≦Vᵢ(Rᵢ)≦Vᵢ(R_{I}^{K0,-}). We have:
   Vᵢ(Rᵢ)≧Vᵢ(Rᵢ^{K*,-}) [symbol] U(R_{i,j}^{K}(Rᵢ,R_{j*})≧−1
   Vᵢ(Rᵢ)≦Vᵢ(Rᵢ^{K0,-}) [symbol] U(R_{i,j}^{K}(Rᵢ,sⱼ))≦−1
From this we deduce that there exists Rⱼε[sⱼ,Rⱼ*] such that U(R_{i,j}^{K}(Rᵢ,Rⱼ))=−1.
Let εᵢ×Rᵢ^{K*,0}≦εᵢ×Rᵢ≦εᵢ×Rᵢ^{K0,0}. Then Vᵢ(Rᵢ^{K*,0}) ≦Vᵢ(Rᵢ)≦Vᵢ(Rᵢ^{K0,0}). We have:
   Vᵢ(Rᵢ)≧Vᵢ(Rᵢ^{K*,)}) [symbol] U(R_{i,j}^{K}(Rᵢ,Rⱼ))≧0
   Vᵢ(Rᵢ)≦Vᵢ(Rᵢ^{K0,0}) [symbol] U(R_{i,j}^{K}(Rᵢ,sⱼ))≦0
From this we deduce that there exists Rⱼε[sⱼ,Rⱼ*] such that U(R_{i,j}^{K}(Rᵢ,Rⱼ))=0.
If εᵢ×Rᵢ>εᵢ×Rᵢ^{K0,0}, then, for all R_{J}ε[sⱼ,Rⱼ*] U(R_{i,j}^{K}(Rᵢ,Rⱼ))≧U(R_{i,j}^{K}(sᵢ,sⱼ))>0
From this we deduce that the level curve U(R_{i,j}^{K}(Rᵢ,Rⱼ))=0 does not pass through the rectangle εᵢ×Rᵢ>εᵢ×Rᵢ^{K0,0}, Rⱼε[sⱼ,Rⱼ*].

Clearly, we have εᵢ×Rᵢ^{K*,-}<εᵢ×Rᵢ^{K0,0} since:
εᵢ×Rᵢ^{K*,-}<εᵢ×Rᵢ^{K0,0} [symbol] Vᵢ(Rᵢ^{K*,-})<Vᵢ(Rᵢ^{K0,0}) [symbol] −1−Vⱼ*−Σ_{qεA+\j} V_{q}^{kq}<Σ_{qεA+\j} V_{q}^{kq}

This last condition is true since Vⱼ*≧0.

On the other hand, it is easy to see that it is certain that for all Rᵢ such that εᵢ×Rᵢ^{K*,-}≦εᵢ×Rᵢ≦εᵢ×Rᵢ^{K0,0}, at least one of the two level curves U(R_{i,j}^{K}(Rᵢ,Rⱼ))=0 or U(R_{i,j}^{K}(Rᵢ,Rⱼ))=−1 is attained for an Rⱼε[sⱼ,Rⱼ*] if and only if the two intervals [Rᵢ^{K*,-}, Rᵢ^{K0,-}] and (Rᵢ^{K*,0}, Rᵢ^{K0,0}] intersect. This latter condition states that there is no hole between the two intervals. This may be written εᵢ×Rᵢ^{K*,0}≦εᵢ×Rᵢ^{K0,-}. We have:
εᵢ×Rᵢ^{K*,0}≦εᵢ×Rᵢ^{K0,-} [symbol] Vᵢ(Rᵢ^{K*,0})≦Vᵢ(Rᵢ^{K0,-}) [symbol] −Vⱼ*−Σ_{qεA+\j} V_{q}^{kq}≦−1−Σ_{qεA+\j}V_{q}^{kq} [symbol] Vⱼ*≧1

Stated otherwise, for all Rᵢ such that εᵢ×Rᵢ^{K*,-}≦εᵢ×Rᵢ≦εᵢ×Rᵢ^{K0,0}, at least one of the two level curves U(R_{i,j}^{K}(Rᵢ,Rⱼ))=0 or U(R_{i,j}^{K}(R_{i,j}^{K}(Rᵢ,Rⱼ))=−1 is attained for an Rⱼε[sⱼ,Rⱼ*] if and only if Vⱼ*≧1.

We will now return to R_{i,j}^{K+}(Rⱼ). We want the set of values that can be taken by U(R_{i,j}^{K+}(Rⱼ)) when Rⱼ describes [sⱼ,Rⱼ*] to cut one of the two level curves 0 or −1 for all kᵢε{−pᵢ−1, . . . ,−1}. To do this, according to the foregoing, it is necessary for j to satisfy Vⱼ*≧1 and that εᵢ×Rᵢ^{K*,-}≦εᵢ×Rᵢ^{k}≦εᵢ×Rᵢ^{K0,0}.

We have:
∃ Rⱼε[sⱼ,Rⱼ*] such that U(R_{i,j}^{K+}(Rⱼ))=0 [symbol]
   εᵢ×Rᵢ^{K*,0}≦εᵢ×Rᵢ^{k}≦εᵢ×Rᵢ^{K0,0} [symbol] Vᵢ^{k}ε[Vᵢ(Rᵢ^{K*,0}) , Vᵢ(Rᵢ^{K0,0})] [symbol] Vᵢ^{k}ε[−Vⱼ*−Σ_{qεA+\j}V_{q}^{kq}, −Σ_{qεA+\j} V_{q}^{kq}]

If k_{q}=0 for all qεA⁺\j, then V_{q}^{kq}=0 and hence this gives:
∃ Rⱼε[sⱼ,Rⱼ*] such that U(R_{i,j}^{K+}(Rⱼ))=0 [symbol] Vᵢ^{k}ε[−Vⱼ*, 0 ]

Hence if k is very small, then we expect Vᵢ^{k} to be close to 0. In this case, the values k₁ which will make it possible to cross the zero level curve will be 0 or in any case small.

Moreover we have:
∃ Rⱼε[sⱼ,Rⱼ*] such that U(R_{i,j}^{K+}(Rⱼ))=−1 [symbol]
   εᵢ×Rᵢ^{K*,-}≦εᵢ×Rᵢ^{k}≦εᵢ×Rᵢ^{K0,-} [symbol] Vᵢ^{k}ε[Vᵢ(Rᵢ^{K*,-}), Vᵢ(Rᵢ^{K0,-})] [symbol] Vᵢ^{k}ε[−1−Vⱼ*−Σ_{qεA+\j}V_{q}^{kq}, −1−Σ_{qεA+\j}V_{q}^{kq}]

If k_{q}=p_{q}+1 for all qεA⁺\j, then V_{q}^{kq}=V_{q}* and hence this gives:
∃Rⱼε[sⱼ,Rⱼ*] such that U(R_{i,j}^{K+(R}ⱼ))=0 [symbol] Vᵢ^{k}ε [−1−Σ_{qεA+}V_{q}*, −1−Σ_{qεA+\j}V_{q}*] [symbol] Vᵢ^{k}ε[Vᵢ,*, Vᵢ,*+Vⱼ*]

Hence if k is large, then we expect Vᵢ^{k} to be close to Vᵢ,*. In this case, the values k₁ which will make it possible to cross the −1 level curve will be equal to p_{q}+1or in any case large.

We proceed in the following manner for the determination of the parameters. The utility functions are determined as and when required. During the running of the algorithm, we denote by D⁺ the set of variables Rⱼ for which the positive part of the utility function Vⱼ is determined, and by D⁻ the set of variables Rᵢ for which the positive part of the utility function Vᵢ is determined. At the start of the algorithm we have D⁺=Ø and D⁻=ØO.

We shall now give the details of the algorithm. The steps are numbered by a label always beginning with C12-R1. The title C2 signifies that we are in case 2 (that is to say we determine the utility functions at every point) while R1 signifies that all the variables are assumed to belong to the compensation framework R1.

The process of the invention is composed of the following steps:

C2-R1-1—Definition of the reference thresholds s₁, . . . , sₙ: This step is strictly identical to step C1-R1-1.

C2-R1-2—Definition of the values Rⱼ* for jεI⁺: This step is strictly identical to step C1-R1-2.

C2-R1-3—Definition of the values Rₖ,* for kεI⁻: This step is strictly identical to step C1-R1-2.

C2-R1-4—Determination of the points Rₖ⁻¹, . . . ,Rₖ^{p-p′k} for kεI⁻: We ask the expert to give the relevant intermediate points between sₖ and Rₖ,*. In general it is not necessary to have many of them. From one to three points are sufficient most of the time.

C2-R1-5—Determination of the points Rⱼ¹, . . . ,Rⱼ^{pj} for jεI⁺: We ask the expert to give the relevant intermediate points between Rⱼ* and sⱼ. We put D⁺=Ø and D⁻=Ø before arriving at the next step.

C2-R1-6—Determination of iεI⁻\D⁻ of reference, and characterization of Vⱼ^{k} for all jεI⁺(i)\D⁺ and kε{1, . . . ,pⱼ+1}: We begin by determining a reference index iεI⁻\D⁻. This step is strictly identical to step C1-R1-6. In particular we ask the question Q4[C1-R1] to determine this index i.

Let jεI⁺(i)\D⁺. Let kε{1, . . . ,pⱼ+1} and let K be the index set defined on A⁺ (for A⁺ such that (A⁺,A⁻)εI, iεA⁻ and jεA⁺) by K_{q}=0 if qεA⁺\j and Kⱼ=k. Rᵢ^{K,0} does not depend on A⁺. We ask the expert to provide the value of Rᵢ^{K,0}:
Q4[C2-R1]: For R_{q} fixed at s_{q} for q≠i,j, onward of (if εᵢ=1)/up to (if εᵢ=−1) what value of Rᵢ do you think that the variable Rⱼ=Rⱼ^{k} compensates entirely for Rᵢ?

As U(Rᵢ^{K-}(Rᵢ^{K,0}))=0, we must have:
Vⱼ^{k}+Vᵢ(Rᵢ^{K,0})=0 (3-[C2-R1])

From the reference index i, we determine Rᵢ^{K,0} for all jεI⁺(i)\D⁺ and all kε{1, . . . ,pⱼ+1]. The equation (3-[C2-R1]) therefore provides a relation satisfied by Vⱼ^{k} for all jεI⁺(i)\D⁺ and all kε{1, . . . ,pⱼ+1).

The variable i is added to the set D⁻, and the set I⁺(i)\D⁺ is added to D⁺. If D⁻≠I⁻, we return to step C2-R1-6. If D⁻=I⁻, all the values Vⱼ^{k} (for all jεI⁺ and all kε{1, . . . ,pⱼ+1}) are characterized by relation type (3-[C2-R1]). In the next step we will be concerned with characterizing Vᵢ^{k}.

C2-R1-7—Determination of a ranking over I⁺: We must fix a reference index jεI⁺\D⁺. We want to take j for which Vⱼ* is a maximum. In contradiction to the previous step, since we already have information we want to avoid asking the expert a question to determine the reference index j. We wish to obtain a kind of ranking among the indices of I⁺. The reference indices will be taken in the order established by this ranking.

As we do not yet know the value of Vⱼ*, we base ourselves on the knowledge of the Rᵢ^{K,0}, where i is a reference index of step C2-R1-6. During step C2-R1-6, the expert was able to provide several reference indices i. We therefore start from the order in which the expert provided the reference indices i. Indices j in I⁺(i)\Dᵢ⁺ (where Dᵢ⁺ is the value of D⁺ at the moment at which step C2-R1-6 is at the level of the reference index i) for a reference index i will all be preferred to the indices I⁺(i′)\D_{i′}⁺ for another reference index i′ if the expert gave i before i′. The union of all the sets I⁺(i)\Dᵢ⁺ for all the reference indices i is equal to I⁺. It now therefore suffices to explain how to order the various indices out of I⁺(i)\Dᵢ⁺ for a fixed index i. For jεI⁺, according to equation (3-[C2-R1]), the value Rᵢ^{K,0} satisfies Vⱼ*+Vᵢ(Rᵢ^{K,0})=0. From this we deduce that the smaller is Vᵢ(Rᵢ^{K,0}), the larger is Vⱼ*, and hence that Rᵢ^{K,0} is small (if εᵢ=1)/large (if εᵢ=−1). We therefore rank the indices jε I⁺(i)\Dᵢ⁺ in increasing (if εᵢ=1)/decreasing (if εᵢ=−1) order of Rᵢ^{K,0}.

We again put D⁺=Ø and D^{-=Ø before going to the next step.}

C2-R1-8—Determination of reference jεI⁺\D⁺ and characterization of Vᵢ^{k} for all iεI⁻(j)\D⁻ and kε{−p′ᵢ−1, . . . ,−1}: The reference index jεI⁺\D⁺ considered is the smallest index belonging to I⁺\D⁺ in the order defined in the previous step. If I⁻(j)\D⁻=Ø, we add j to D⁺ and we again determine a reference index jεI⁺\D⁺.

Let iεI⁻(j)\D^{-. Let kε{-p′}ᵢ−1, . . . ,−1}. Let (A⁺,A⁻)εI with iεA⁻ and jεA⁺.

We must determine the values of the indices k_{q} for qεA⁺\j for which the set of values that can be taken by U(R_{i,j}^{K+}(Rⱼ)) when Rⱼ describes [Rⱼ*,sⱼ] cuts one of the 0 or −1 level curves. We make use of what was established hereinabove in regard to the particular points on the two 0 and −1 level curves of U.

The determination of the indices {k_{q}}_{qεA+\j} is described hereinbelow in regard to the utility functions determined at every point for I⁺ and I⁻. We firstly consider the case of the 0 level curve. We ask the expert to provide the value of Rⱼ for which U(R_{i,j}^{K+}(Rⱼ))=0:
Q5: Onward of (if εⱼ=1)/up to (if εⱼ=−1) what value of Rⱼ do you think that the variables Rⱼ and R_{q}=R_{q} for qεA⁺\{j} compensate entirely for Rᵢ=Rᵢ^{k} and R_{q}=s_{q} for qεA⁻\{i}?

We write Rⱼ^{iK,0} for this value. We must have:
Vᵢ^{k}+Vⱼ(Rⱼ^{iK,0})+Σ_{qεA+\(j)}V_{q} ^{q}=0 (4-[C2-R1])

If the expert prefers to reason with regard to the −1 level curve, we ask him to provide the value of Rⱼ for which U(R_{i,j}^{K+(R}ⱼ))=−1:
Q5′: Onward of (if εⱼ=1)/up to (if εⱼ=−1) what value of Rⱼ do you think that the variables Rⱼ and R_{q}=R_{q}^{kq} for qεA^{+\{j} compensate entirely for R}ᵢ=Rᵢ^{k} and R_{q}=s_{q} for qεA⁻\{i}?

We write Rⱼ^{iK,0} for this value. We must have:
Vᵢ^{k}+Vⱼ(Rⱼ ^{iK,0})+Σ_{qεA+\{j}}V_{q}^{kq}=−1 (4′-[C2-R1])

We add the variable j to the set D⁺, and the set I⁻(j)\D⁻to D⁻. If D⁺≠I⁺, we return to step C2-R1-8.

C2-R1-9—Determination of the parameters in the compensation situations: we shall now refer to the equations obtained. Relation (1-[C1-R1]) gives the value of s_{q} for all q. We set these equations aside, since this amounts to not considering V_{q}(s_{q}) as an unknown. Thus, the unknowns are Vᵢ^{k} for iεA⁻, kε{−p′ᵢ−1, . . . ,−1} and Vⱼ^{k} for jεA⁺, kε{1, . . . ,pⱼ+1}. This gives Σ_{qε{1, . . . ,n}} (p_{q}+1) unknowns. On the other hand, we have the relation (3-[C2-R1]) for all jεA⁺, kε{1, . . . ,pⱼ+1}, and the relation (4-[C2-R1]) or (4′-[C2-R1]) for all jεA⁻and kε{−p′ⱼ−1, . . . ,−1}. In total this gives Σ_{qε{1, . . . ,n}} (p_{q}+1) equations. To this must be added the conditions on the type of compensation. In the general case, this amounts to introducing a certain number of equations and inequalities in real variables and {0, 1}, as described hereinbelow with reference to the determination of the particular point. We therefore have as many unknowns as equations. This therefore allows us to calculate a unique solution, if it exists. We can also add the following constraints:
Vⱼ¹≦Vⱼ²≦. . . ≦Vⱼ^{pj+1} ∀ JεI⁺ and Vᵢ⁻¹≧Vᵢ⁻²≧. . . ≧Vᵢ^{-p′i-1} ∀ iεI⁻

We can solve a linear problem by minimizing the sum of errors over all the equations. If we insist that, out of all the inequalities in (2-[C1-R1]), one is an equality, we obtain a linear integer program.

C2-R1-10 to C2-R1-12: These steps are strictly identical to steps C1-R1-9 to C1-R1-11.

We will now examine the general case for which we assume that we can have a mixture between the cases [symbol] ₁, [symbol] ₂ and [symbol] ₃.

We firstly consider the utility functions determined at the extremities. The utility functions are determined as and when required. During the running of the algorithm, we denote by D⁺ the set of variables Rⱼ for which the positive part of the utility function Vⱼ is determined, and by D the set of variables Rᵢ for which the positive part of the utility function Vᵢ is determined. At the start of the algorithm we have D⁺=Ø and D⁻=Ø.

We assume that, for all i, the variable Rᵢ satisfies the following hypothesis:

H-[C1-R*]: For R₋ᵢ fixed to s₋ᵢ, the compensation becomes completely impossible beyond a certain value of Rᵢ.

Stated otherwise, a very bad value of Rᵢ can no longer be compensated at all in respect of the neutral values (equal to the thresholds) along the other variables. This condition implies the following relation:
∀ᵢ, Vᵢ,* <−1 (1-[C1-R*])

We shall now give the details of the algorithm. The steps are numbered by a label always beginning with C1-R*1. The title C1 signifies that we are in case 1 (that is to say that we determine the utility functions solely at the extremities) while R* signifies that the variables may belong to any of the three compensation cases R1, R2 or R3.

The steps depend in part on the type of compensation considered (R1, R2 or R3). When a step depends on the type of compensation, we place a reminder of the corresponding compensation between brackets at the end of the step number. The process is based on the following steps:

C1-R*-1—Definition of the reference thresholds s₁, . . . , sₙ: This step is strictly identical to step C1-R1-1.

C1-R*-2—Definition of the values Rⱼ* for jεI⁺: This step is strictly identical to step C1-R1-2.

Determination of the Vᵢ for iε [symbol] ₁: The steps whose number terminates with a square bracket [1] are specific to case R1 (iε [symbol] ₁). They will be split into cases R2 and R3 respectively with square brackets [2] and [3]. The steps that do not carry any square bracket are generic and are not repeated in cases R2 and R3.

C1-R*-3[1]—Definition of the values Rₖ,* for kεI⁻:

This step is strictly identical to step C1-R1-2.

C1-R*-4—Determination of the utility function Vₖ between Rₖ,* and sₖ for kεI⁻: This step is strictly identical to step C1-R1-4.

C1-R*-5—Determination of the utility function Vⱼ between sⱼ and Rⱼ* for jεI⁺: This step is strictly identical to step C1-R1-5.

C1-R*-6[1]—Determination of reference iε [symbol] ₁\D⁻: The questionnaire will be based on a particular variable from among [symbol] ₁\D⁻. This step is identical to step C1-R1-6.

C1-R1-7[l]—Determination of Vᵢ,* and Vⱼ* for all jεI⁺(i)\D⁺: Let jεI⁺(i)\D⁺. This step is identical to step C1-R1-7. By virtue of the question Q5[C1-R1], we determine R_{i,j}⁰. As in step C1-R1-7, we have:
Vᵢ,*=Λ_{(A+,A-)εI/iεA-}−(1+Σ_{jεA+∩+}Vⱼ*)/(1−Σ_{jεA+λ}ᵢ(R_{i,j}⁰) (2-[C1-R*])

The expression for Vⱼ* for all jεI⁺(i)\D⁺ is:
Vⱼ*=−λᵢ(R_{i,j}⁰)×Λ_{(A+,A-)εI/iεA-}−(1+Σ_{jεA+∩D+}Vⱼ*)/(1-Σ_{jεA+}λᵢ(R_{i,j}⁰)) (3-[C1-R*])

We add the variable i to the set D⁻ and the set I⁺(i)\D⁺ to D⁺. If D⁻≠I⁻ we return to a step C1-R1-6[1], C1-R1-6[2] or C1-R1-6[3].

C1-R*-8[1]—Determination of Vₖ,* for kε [symbol] ₁ ∩ (I⁻\D⁻) such that I⁺(k)⊂D⁺: For all kε [symbol] ₁ ∩ (I^{-\D}⁻) such that I⁺(i)⊂D⁺, we proceed exactly as in step C1-R1-8. The value of Vₖ,* is then given by formula (6-[C1-R1]).

We then proceed to the determination of the Vᵢ for iε [symbol] ₂ as follows.

C1-R*-3[2]—Definition of the values Rₖ,* for kεI⁻:

Below (if εₖ=1)/onward (if εₖ=−1) of Rₖ,*, the utility function Vₖ remains stuck at the value Vₖ,* and no longer decreases. In contradiction to compensation of the type R1, there is no limit behavior in the variable Rₖ beyond Rₖ,* with a compensation of the type R2. To determine Rₖ,*, the expert answers the following question:
Q1[C1-R*]: Onward of (if εₖ=1) /below (if εₖ=−1) what value of Rₖ do you wish to no longer further penalize the compensation?

C1-R*-6[2]—Determination of reference iε [symbol] ₂\D⁻: The questionnaire will be based on a particular variable out of [symbol] ₂\D⁻. This step is identical to step C1-R1-6. According to the condition given previously for R2, we have:
∃B(A⁺,A⁻)εI such that iεA⁻, we have 0<Vᵢ,* +Σ_{jεA+v}ⱼ* (4-[C1-R*])

We ask the expert the pair (A⁺,A⁻) for which the previous inequality is satisfied.
Q2[C1-R*]: In which compensation situation, regardless of the value of Rᵢ (even very bad), do we compensate entirely for sufficiently good values of the other variables?

C1-R*-7[2]—Determination of Vᵢ,* and Vⱼ* for all jεA⁺\D⁺: For all jεA⁺\D⁺, we ask the following question:
Q3[C1-R*]: For R_{-(i,j)} fixed at s_{-(i,j)}, the variable Rⱼ at the value Rⱼ does it compensate at least a little for the variable Rᵢ at the value Rᵢ,*?
If the reply to Q3[C1-R*) is positive, then this signifies that Vᵢ,*+Vⱼ*>−1. So consider the vector of variables R(Rⱼ) such that: (R(Rⱼ))ⱼ=Rⱼ, (R(Rⱼ))ᵢ=Rᵢ,* and (R(Rⱼ))ₖ=sₖ for k∉{i,j}. We have: U(R(Rⱼ))=Vⱼ(Rⱼ)+Vᵢ,*. For Rⱼ=sⱼ, we have: U(R(sⱼ))=Vᵢ,*<−1 according to (1-[C1-R*]), and for Rⱼ=Rⱼ, we have U(R(Rⱼ*))=Vⱼ*+Vᵢ,*>−1 according to the reply to the question Q5[C1-R2]. From this we deduce that there exists Rⱼ⁰ lying between sⱼ and Rⱼ* such that U(R(Rⱼ*))=−1. As Vᵢ,*<−1 we have Rⱼ⁰<sⱼ and therefore λⱼ(Rⱼ⁰)>0. To determine Rⱼ⁰, the expert answers the following question:
Q3[C1-R*]: For R_{-{i,j}} fixed at s_{-{i,j}}, up to (if εⱼ=1)/onward of (if εⱼ=−1) what value of Rⱼ do you think that the variable Rᵢ at the value Rᵢ,* is no longer compensated for at all?

As U(R(Rⱼ⁰))=−1, we have:
Vᵢ,* +λⱼ(Rⱼ⁰) Vⱼ*=−1 (5-[C1-R*])

If the reply to Q3[C1-R*] is negative, then this signifies that Vᵢ,*+Vⱼ*≦−1. So consider the vector of variables R(Rᵢ) such that (R(Rᵢ))ᵢ=Rᵢ, (R(Rᵢ))ⱼ=Rᵢ* and (R(Rᵢ))ₖ=sₖ for k∉{i,j}. We have: U(R(Rᵢ))=Vᵢ(Rᵢ)+Vⱼ*. For Rᵢ=sᵢ, we have: U(R(sᵢ))=Vⱼ*≧0, and for Rᵢ=Rᵢ,* we have: U(R(Rᵢ,*))=Vᵢ,*+Vⱼ*<−1 according to the reply to question Q5[C1-R2]. From this we deduce that there exists Rᵢ⁰ lying between sᵢ and Rᵢ,* such that U(R(Rᵢ⁰))=−1. To determine Rᵢ⁰, the expert answers the following question:
Q3′[C1-R*]: For R_{-(i,j)} fixed at s_{-{i,j}}, onward of (if εᵢ=1)/below (if εi=−1) what value do you think that Rᵢ can no longer be compensated at all by Rⱼ at the value Rⱼ*?As U (R(Rᵢ⁰))=−1, we have:
   Vⱼ*+λᵢ(Rᵢ⁰)Vᵢ,*=−1 (5′-[C1-R*])

We put: τᵢⱼ=λᵢ(Rᵢ⁰) if Vᵢ,*+Vⱼ*≦−1 and τᵢⱼ=1/λⱼ(Rⱼ⁰) if Vᵢ,*+Vⱼ*≧−1. We moreover put Tᵢⱼ=1 if Vᵢ,*+Vⱼ*≦−1, and Tᵢⱼ=1/λⱼ(Rⱼ⁰) if Vᵢ,*+Vⱼ>−1. According to (4-[C1-R2]) and (4′-[C1-R2]), for all jε A⁺\D⁺, we have:
Vⱼ*+τᵢⱼVᵢ,*=−Tᵢⱼ (5″-[C1-R*])

According to (4-[C1-R*])
Vᵢ,* (1−Σ_{jεA+\D+}τᵢⱼ)−Σ_{jεA+\D+}T_{ij +Σ}_{jεA+∩D+}Vⱼ*>0

We consider the equality when the right-hand side equals a fixed positive number κ. Hence:
Vᵢ,*=(κ+Σ_{jεA+\D+}Tᵢⱼ−Σ_{jεA+∩D+}Vⱼ*)/(1−Σ_{jεA+\D+}τᵢⱼ) (6-[C1-R*])

With (5″−[C1-R*]), we obtain, for all jεA⁺D⁺:
Vⱼ*=−Tᵢⱼ−τᵢⱼ×(κ+Σ_{kεA+\D+}Tᵢₖ−Σ_{kεA+∩D+}Vₖ*)/(1−Σ_{kεA+\D+}τᵢₖ) (7-[C1-R*])

We add the variable i to the set D⁻ and the set A⁺\D⁺ to D⁺. If D⁻≠I⁻, we return to a set C1-R1-6[1], C1-R1-6[2) or C1-R1-6[3].

C1-R*-8[2]—Determination of Vₖ,* for kε [symbol] ₂∩I⁻\D⁻ such that I⁺(k)⊂D⁺: For all kε [symbol] ₂ ∩I⁻\D⁻ such that I⁺(i)⊂D^{+, we can determine the value of V}ₖ,*. We ask the question Q2[C1-R*] to determine the pair (A⁺,A⁻) for which the relation (4-[C1-R*]) is satisfied. According to (4-[C1-R*]), we have:
Vₖ,*=κ−Σ_{jεA+}Vⱼ* >0

We obtain:
Vₖ,* =κ−Σ_{jεA+}Vⱼ*

We then proceed to the determination of the Vᵢ for iε [symbol] ₃:

C1-R*-3[3]—Definition of the values Rₖ,* for kεI⁻:

This step is strictly identical to step C1-R*-3[2].

C1-R*-6[3]—Determination of reference iε [symbol] ₃\D⁻: The questionnaire will be based on a particular variable out of [symbol] ₃\D⁻. This step is identical to step C1-R1-6.

C1-R*-7[3]—Determination of Vᵢ,* and Vⱼ* for all jεI⁺(i)\D⁺: For all jεI⁺(i)\D⁺, we proceed exactly as for the start of C1-R*-7[2]. For all jεI⁺(i)\D⁺, we culminate in the relation (5″-[C1-R*]).

The second relation corresponding to the case R3 gives for all (A⁺,A⁻)εI with iεA⁻:
Vᵢ,* (1−Σ_{jεA+\D+}τᵢⱼ)−Σ_{jεA+D+}Tᵢⱼ+Σ_{jεA+∩D+}Vⱼ*≦0

Hence:
Vᵢ,*≦(Σ_{jεA+\D+}Tᵢⱼ−Σ_{jεA+∩D+}Vⱼ*)/(1-Σ_{jεA+\D+T}ᵢⱼ)
and:
Vᵢ,* ≦Λ_{(A+,A-)εI/iεA-}(Σ_{jεA+\D+}Tᵢⱼ −Σ_{jεA+∩D+}Vⱼ*)/(1−Σ_{jεA+\D+}τᵢⱼ)

We take the equality:
Vᵢ,* =Λ_{(A+,A-)εI/iεA-}(Σ_{jεA+\D+}Tᵢⱼ−Σ_{jεA+∩D+}Vⱼ*)/(1−Σ_{jεA+\D+}Tᵢⱼ) (8-[C1-R*])

For the pair (A⁺,A⁻)εI that achieves the minimum, we have: Vᵢ,* +Σ_{jεA+}Vⱼ*=0. This implies that for this pair, we have in particular: Vᵢ,* +Σ_{jεA+}Vⱼ*>−1. From this we deduce that the first relation corresponding to the case R3 is satisfied. Consequently, Vᵢ,* given by (8-[C1-R*]) satisfies the conditions of the case R3.

With (5″-[C1-R*]), we obtain, for all jεI+(i)\D⁺:
Vⱼ*=−Tᵢⱼ−τᵢⱼ×Λ_{(A+,A-)εI/iεA-}(Σ_{jεA+\D+}Tᵢⱼ) −Σ_{jεA+∩D+}Vⱼ*)/(1−Σ_{jεA+\D+}τᵢⱼ) (9-[C1-R*])

We add the variable i to the set D⁻ and the set of I⁺(i)\D⁺ to D⁺. If D⁻≠I⁻, we return to a step C1-R1-6[1], C1-R1-6[2] or C1-R1-6[3].

C1-R*-8[3]—Determination of Vₖ,* for kε [symbol] ₃∩I⁻\D⁻ such that I⁺(k)⊂D⁺: For all kε [symbol] ₃∩I⁻\D⁻ such that I⁺(i)⊂D⁺, we can determine the value of Vₖ,*. The second relation corresponding to the case R3 gives:
Vₖ,*≦Λ_{(A+,A-)εI/kεA-}−Σ_{jεA+}Vⱼ*

As previously, we take the equality:
Vₖ,* =Λ_{(A+,A-)εI/kεA-}−Σ_{jεA+}Vⱼ*

For the pair (A+,A−)εI achieving the minimum, we have: Vₖ,* +Σ_{jεA+}Vⱼ*=0. From this we deduce that the first relation corresponding to the case R3 is satisfied. Consequently, Vₖ,* given by the previous formula satisfies the conditions of case R3.

We then proceed to the determination of the Vⱼ for jεI⁺\D⁺, as follows.

C1-R*-9—Determination of Vⱼ* for all jεI⁺\D⁺: On completion of steps C1-R*-7, if I⁺≠D⁺, this is necessarily due to a case R2, that is to say to a pair (A⁺,A⁻)εI with jεA⁺, for which all the iεA⁻ corresponding to the case R2. Let therefore jεI⁺\D⁺. Let (A⁺,A⁻)εI with jεA⁺. We ask the expert, echoing the step C1-R1-2, for an index iεA⁻ on which a question will be asked. We then proceed exactly as at the start of step C1-R*-7[2]. We culminate in relation (5″-[C1-R*]). This gives the expression for Vⱼ*:
Vⱼ*=−Tᵢⱼ−Tᵢⱼ×Vᵢ,* (9-[C1-R*])

We will now examine how the determination of the parameters goes outside of the framework of compensation.

C1-R*-10—Determination of Vⱼ* for j∉I⁺: This step is strictly identical to step C1-R1-9.

C1-R*-11—Determination of Vᵢ beyond Rᵢ,* for iε [symbol] ₁:

In the framework of a compensation of type R1, it is necessary to ensure that no more compensation is possible below (if εᵢ=1)/beyond (if εᵢ=−1) a certain value of Rᵢ. It is for this reason that we saw that it is necessary to introduce a point Rᵢ,** below (if εᵢ=1)/beyond (if εᵢ=−1) Rᵢ,*. This step is strictly identical to step C1-R1-10.

C1-R*-12—Determination of Rₖ,* and Vₖ,* for k∉I⁻: For k∉I⁻, the variable Rₖ is never presumed to be compensated for by other variables. We therefore assume that the variables that are not a priori among the variables presumed to be compensated according to the expert, belong to the case R1, that is to say to the most restrictive case. We then proceed exactly as in step C1-R1-11.

To determine the utility functions at every point for I⁺ and I⁻, the procedure is similar to what was described above with reference to FIG. 15. We shall not describe it in detail. It involves generalizing steps C2-R1-6 and C2-R1-8. We then seek to determine Vᵢ^{k} for all iεI⁻, kε{−p′ᵢ−1, . . . ,−1} and for all iεI⁺, kε{1, . . . , pᵢ+1}. These are the unknowns in question.

Let i,jεN and A⊂N\{i,j}. Let R be the vector whose coordinates are the following: Rᵢ=Rᵢ^{k}, Rⱼ a nonfixed value, R_{q}=R_{q}^{kq} for all qεA\j, and R_{q}=s_{q} for all qεN\(A∪{i,j}). We have U(R)=Vᵢ^{k}+Vⱼ(Rⱼ)+Σ_{qεA\(j) V}_{q}^{kq}. The vector R therefore employs the utility Vᵢ^{k}. In order to have a relation satisfied by Vᵢ^{k}, we therefore seek to have Rⱼ such that U(R)=0 or U(R)=−1. We therefore seek indices {k_{q}}_{qεA\j} such that when Rⱼ goes from Rⱼ,* to sⱼ, we are certain that U(R) crosses one of the two 0 or −1 level curves. We describe here the manner in which the indices {k_{q}}_{qεA\j} are determined.

For each iεI⁻, kε{−p′ᵢ−1, . . . ,−1} and each iεI⁺, kε{1, . . . , pᵢ+1}, we use this technique to determine a relation satisfied by Vᵢ^{k}. We begin with those for which we do not need to search for the indices {k_{q}}_{qεA\j} numerically (that is to say those for which we know a priori some {k_{q}}_{qεA\j} for which U(R) crosses one of the two 0 or −1 level curves).

To perform the determination of the particular point, the difficulty is that we do not yet know the values of the utilities V_{q}^{kq}. Under these conditions, how does one determine the best indices {k_{q}}_{qεA\j} such that U(R) definitely crosses one of the two level curves? The idea is, based on the elements available to us, to determine the best indices {k_{q}}_{qεA\j} such that it is entirely possible for U(R) to cross one of the two level curves, that is to say that there is no contra-indication from the elements available to us. The elements available to us are grouped into a set denoted Ψ. These are the relations available to us regarding the unknowns. We denote by Ψ the set of equalities originating from the particular points already determined, and from the subsequent relations originating from the type of compensation chosen:
Case where iε [symbol] ₁. For all (A⁺,A⁻)εI such that iεA⁻, we have Vᵢ,* +Σ_{jεA+}Vⱼ*≦−1. Moreover, in order for Rᵢ,* to correspond to its definition given previously, at least one of these inequalities must be satisfied with an equality. This is modeled with the aid of a linear integer problem. This gives:
   For all (A⁺,A⁻)εI such that iεA⁻:
      Vᵢ,* +Σ_{jεA+}Vⱼ*=−1E_{i,A+}
      E_{i,A+}≧0
      ε_{i,A+}ε{0,1}
      ε_{i,A+}≦E_{i,A+}/δ
      ε_{i,A+}≧(E_{i,A+}−δ)/Eₘₐₓ
      Σ_{(A+,A-)εI such that iεA-}(1−ε_{i,A+})≧1
      where δ is a very small number (for example β=10⁻⁸) and Eₘₐₓ is an a priori upper bound of the E_{i,A+} (for example Eₘₐₓ=10⁸). The variables ε_{i,A+} are integers. The relation ε_{i,A+}≦ε_{i,A+}/δ implies that ε_{i,A+}=0 once E_{i,A+}<δ. The relation ε_{i,A+}≧(E_{i,A+}−δ)/Eₘₐₓ implies that E_{i,A+}=1 once E_{i,A+}>δ. In all, ε_{i,A+}=0 if Vᵢ,* +Σ_{jεA+}Vⱼ*=−1 and ε_{i,A+}=1 if Vᵢ,* +Σ_{jεA+}Vⱼ*<−1. From this we deduce that Σ_{(A+,A-)εI such that iεA-} (1−ε_{i,A+}) gives the number of (A+,A−)εI for which we have equality in Vᵢ,* +Σ_{jεA+}Vⱼ*≦−1. The relation Σ_{(A+,A-)εI} such that iεA− (1−ε_{i,A+})≧1 indicates therefore that at least one of these inequalities is satisfied with an equality.
Case where iε [symbol] ₂. For all (A⁺,A⁻)εI such that iεA⁻ we have Vᵢ,* +Σ_{jεA+}Vⱼ* ≧0. We write this in the following manner: for all (A⁺,A⁻)εI such that iεA^{- we have V}ᵢ,* +Σ_{jεA+}Vⱼ*≧γ (with γ very small). Moreover, in order for Rᵢ,* to correspond to its definition given previously, at least one of these inequalities must be satisfied with an equality. We model this with the aid of a linear integer problem. This way of doing things is similar to that of the previous case.
   For all (A⁺,A⁻)εI such that iεA⁻:
      Vᵢ,* +Σ_{jεA+}Vⱼ=γ+E_{i,A+}
      E_{i,A+}≧0
      E_{i,A+}ε{0,1}
      ε_{i,A+}≦E_{i,A+}/δ
      ε_{i,A+}≧(E_{i,A+}−δ)/Eₘₐₓ
      Σ_{(A+,A-)εI such that iεA-}(1−ε_{i,A+})≧1
Case where iε [symbol] ₃. No additional condition is imposed other than the conditions on [symbol] ₃. This gives:
   For all (A⁺,A⁻)εI such that iεA⁻:
      −1<Vᵢ,*+_{jεA+}Vⱼ*≦0

We saw previously that:
∃Rⱼε[sⱼ,Rⱼ*] such that U(R)=0 [symbol] Vᵢ^{k} ε[−Vⱼ(Rⱼ) −Σ_{qεA} V_{q}^{kq}, −Σ_{qεA V}_{q}^{kq}] (1)
∃Rⱼε[sⱼ,Rⱼ*] such that U(R)=−1 [symbol] Vᵢ^{k} ε[−1−Vⱼ(Rⱼ) −Σ_{qεA} V_{q}^{kq}, −1−Σ_{qεA} V_{q}^{kq}] (2)

We therefore want (1) or (2) to be satisfied: Let:
L′={(vⱼ*,vᵢ^{k}, {v_{q}^{kq}}_{qεA}) such that Ψ∪{Vⱼ*=vⱼ*}∪{Vᵢ^{k}=vᵢ^{k}}∪{V_{q}^{kq}=v_{q}^{kq}}_{qεA}∪{(1) or ( 2)}≠Ø}
L={(vⱼ*, (v_{q}^{kq}}_{qεA}) such that ∃ vᵢ^{k} with (vⱼ*, vᵢ^{k}, {v_{q}^{kq}}qεA) εL}

The set L provides the values of the variables vⱼ*,vᵢ^{k},{v_{q}^{kq}}_{qεA} that are compatible with ψ, and (1) or (2). Stated otherwise, if L≠Ø then (1) or (2) will be achievable and U(R) will cut one of the two 0 or −1 level curves for a value of Rⱼ. We want L≠Ø. To go further, we want to maximize the span of the possible vᵢ^{k}. Specifically, the more possible values of Vᵢ^{k} there are, the more margin we will have as regards (1) or (2). Let:
r_{L}=Λ_{(vj*,{vqkq}qεA)εL} (ν_{(vj*,vik,{vqkq}qεA)εL′} Vᵢ ^{k} −Λ_{(vj*, vik,{vqkq}qεA)εL′}vᵢ^{k})

We therefore want to choose {k_{q}}_{qεA} so as to maximize r_{L}. This number is not easy to calculate. We seek an approximation thereof that is simple to calculate.
Let
Vⱼ*=Λ_{vj* such that ψ∪{Vj*=vj*}≠Ø}vⱼ* and \overline{V}ⱼ*=Λ_{vj* such that ψ∪{Vj*=vj*}≠Ø} vⱼ*
Vᵢ^{k}=Λ_{vik such that ψ∪{Vik=vik}≠Ø} Vᵢ^{k} and \overline{V}ᵢ^{k}=ν_{vik such that ψ∪{Vik=vik}≠Ø} vⱼ*
λ=Λ_{{vqkq}qεA such that ψ∪{Vqkq=vqkq}qεA ≠Ø} Σ_{qεA} V_{q}^{kq}
and \overline{λ}=Λ_{{vqkq}qεA such that ψ∪{Vqkq=vqkq}qεA ≠Ø} Σ_{qεA} V_{q}^{kq}
Let:
M′={(vⱼ*, vᵢ^{k}, {v_{q}^{kq}}_{qεA}) such that vⱼ* ε[Vⱼ*, \overline{V}ⱼ*, Vᵢ^{k}ε[Vᵢ^{k}, \overline{V}ᵢ^{k}], Σ_{qεA} V_{q}^{kq}ε[λ, \overline{λ}] and (1) or (2)}
M={(vⱼ*,v_{q}^{kq}}_{qεA}) such that ∃ vᵢ^{k} with (vⱼ*,vᵢ^{k}, {v_{q}^{kq}}_{qεA})εM}

We have L′⊂M′ and L⊂M. M and M′ are therefore over approximations of the sets L and L′. Let:
r_{M}=Λ_{(vj*,{vqkq}qεA)εM} (ν_{(vj*,vik,{vqkq}qεA)εM′} Vᵢ^{k} −ν_{(vj*,vik,{vqkq}qεA)εM′} vᵢ^{k})

As L′⊂M′ and L⊂M, it follows that:
r_{M}≧r_{L}

The number r_{M} is very easy to calculate. Indeed, we put:

p=0 if we consider relation (1)

p=1 if we consider relation (2)

Firstly, we observe that:
rₘ=min {r(vⱼ*,λ), vⱼε[Vⱼ*, \overline{V}ⱼ*], λε[λ, \overline{λ}]}
where:
r(vⱼ*,λ)=|[Vᵢ^{l},\overline{V}ᵢ^{k}]∩[−vⱼ*−λ−p,−λp]|

For an interval T=[T₀,T₁,], the length |T| of this interval is defined by T₁−T₀. We have:
r_{M}=0 [symbol] \overline{V}ᵢ^{k}≦−Vⱼ*−λ or Vᵢ^{k}≧−\overline{λ}A

Moreover, it is easy to see that:
r_{M}=r(Vⱼ*,λ) Λ r(Vⱼ*,\overline{λ})

The indices {k_{q}}_{qεA+\j} considered are those which maximize r_{L} (if we wish to solve the exact problem) or r_{M} (if we are content with the approximate problem).

1. A method of decision making by an expert system in the absence of clearly identifiable rules, according to which this system one establishes decision making rules comprising at least two variables for each of which at least one limit is not strict, comprising the steps of:
asking questions with a view to allowing the system to introduce a compensation condition into the nonclearly identifiable rules;
determining one expert with the system, for each parameter of a compensatory condition, at least one particular point belonging to a compensation boundary and connected with the parameter; and
deducing the system therefrom the value of the parameters, that it one applies the set of rules and that it that one deduces the decision therefrom.

2. The method as claimed in claim 1, wherein the compensation either holds or does not hold, and that there is just one single compensation boundary.

3. The method as claimed in claim 1, wherein the conditions in the premises are rendered fuzzy by the expert, that the compensation may hold to a greater or lesser extent, that there are two compensation boundaries, that the application of the rules makes it possible to calculate a degree of possibility regarding the set of possible alternatives, and that the system one must interpret the final distributions of possibility so as to deduce the decision therefrom.

4. The method as claimed in claim 1, wherein the compensation condition is written as the aggregation by a simple unweighted sum of utility functions on each variable, that the utility functions are piecewise affine, that an the expert provides the abscissa of the points delimiting the affine parts, and that the parameters of the compensation condition are the ordinates of these points.

5. The method as claimed in claim 4, wherein the expert provides in relative terms with respect to the extreme values the ordinates of the utility functions for all points delimiting the affine parts except for the two extreme points and the threshold, that the utility at the threshold is zero and that the parameters of the compensation condition are the ordinates of the utility functions for the extreme points.

6. The method as claimed in claim 4, wherein the utility at the threshold is zero and that the parameters of the compensation condition are the ordinates of the utility functions for all points delimiting the affine parts except for the threshold.

7. The method as claimed in claim 5, wherein the particular points are such that all their coordinates according to the variables except one are equal to one of the values delimiting the affine parts of the utility functions, that the system one requests the expert to provide the value according to the nonfixed coordinate so that the particular point is situated exactly on a compensation boundary, that the system one determines a characteristic point for every variable and every value delimiting the affine parts of the utility function on this variable such that the coordinate of the characteristic point along the variable is equal to the value and such that the ordinate of this value is a parameter, that the relations that one has on the characteristic points culminate in a set of system equations whose unknowns are the parameters, and that the system solves this set with a suitable classical procedure.

8. The method as claimed in claim 7, wherein the expert determines for each variable the type of compensation to which it belongs, that this provides a set of equations and of inequalities, that it is necessary to append the equations arising from the characteristic points, and that the system one solves this system according to a classical procedure.

9. The method as claimed in claim 7, wherein all the variables correspond to a compensation of the type for which, for each variable Rᵢ, there exists a value of Rᵢabove or below which no more compensation is possible regardless of the value according to the other variables, that the expert provides as relative values with respect to the extreme values the ordinates of the utility functions for all points delimiting the affine parts except for the two extreme points and the threshold, that the utility of the threshold is zero, that the parameters of the compensation condition are the ordinates of the utility functions for the extreme points, that fuzziness is introduced, that the conditions in the premises are rendered fuzzy by the expert, that the compensation may hold to a greater or lesser extent, that the characteristic points are such that the component along a well-satisfied variable corresponds to the maximum value along this variable, that the component along a poorly satisfied variable is free, that the system one asks the expert to provide the value along the free coordinate so that the particular point is situated exactly on a compensation boundary and that all the other components are fixed at the thresholds.

10. The method as claimed in claim 1, wherein the rule base corresponds to a decision tree.

11. The method as claimed in claim 3, wherein the rule base corresponds to a decision tree, and that a single alternative may be entirely possible in the final distribution of possibilities.

12. The method as claimed in claim 11, wherein the system one reveals in the decision tree the pairs of complementary conditions, including the compensation conditions, that the system one processes the complementary conditions at the same time while separating the kernel of their fuzzy set by a very small number.

13. The method as claimed in claim 11, wherein the system one commences by formally introducing compensation, then that the system one formally introduces fuzziness, then that the system one specifies the noncompensatory fuzzy conditions, and finally that the system one specifies the compensatory fuzzy conditions.

14. The method as claimed in claim 2, wherein the compensation condition is written as the aggregation by a simple unweighted sum of utility functions on each variable, that the utility functions are piecewise affine, that an the expert provides the abscissa of the points delimiting the affine parts, and that the parameters of the compensation condition are the ordinates of these points.

15. The method as claimed in claim 3, wherein the compensation condition is written as the aggregation by a simple unweighted sum of utility functions on each variable, that the utility functions are piecewise affine, that an the expert provides the abscissa of the points delimiting the affine parts, and that the parameters of the compensation condition are the ordinates of these points.

16. The method as claimed in claim 6, wherein the particular points are such that all their coordinates according to the variables except one are equal to one of the values delimiting the affine parts of the utility functions, that the system one requests the expert to provide the value according to the nonfixed coordinate so that the particular point is situated exactly on a compensation boundary, that the system one determines a characteristic point for every variable and every value delimiting the affine parts of the utility function on this variable such that the coordinate of the characteristic point along the variable is equal to the value and such that the ordinate of this value is a parameter, that the relations that one has on the characteristic points culminate in a set of system equations whose unknowns are the parameters, and that the system solves this set with a suitable classical procedure.

17. The method as claimed in claim 12, wherein the system one commences by formally introducing compensation, then that the system one formally introduces fuzziness, then that the system one specifies the noncompensatory fuzzy conditions, and finally that the system one specifies the compensatory fuzzy conditions.
